(19) United States
(12) Patent Application Publication
(10) Pub. No.: US 2020/0001533 A1
(43) Pub. Date: Jan. 2, 2020

(54) METHODS AND SYSTEMS FOR ADDITIVE MANUFACTURING

(71) Applicant: VALORBEC SOCIETE EN COMMANDITE, MONTREAL (CA)

(72) Inventors: MUTHUKUMARAN PACKIRISAMY, MONTREAL (CA); MOHSEN HABIBI, WESTMOUNT (CA)

(21) Appl. No.: 16/483,494

(22) PCT Filed: Feb. 7, 2018
(86) PCT No.: PCT/CA2018/000023

§ 371 Date: Aug. 5, 2019

Related U.S. Application Data
(60) Provisional application No. 62/455,750, filed on Feb. 7, 2017.

(51) Int. Cl. B29C 64/277; B33Y 30/00; B33Y 50/02; B22F 3/105; B28B 1/00; B28B 17/00; B29C 64/393; B33Y 10/00; B29C 64/141

(52) U.S. Cl. CPC B29C 64/277; B33Y 30/00; B33Y 50/02; B22F 3/1055; B22F 2003/1057; B28B 17/0081; B29C 64/393; B33Y 10/00; B29C 64/141; B28B 1/001

(57) ABSTRACT

Additive manufacturing (AM) exploits materials added layer by layer to form consecutive cross sections of desired shape. However, prior art AM suffers drawbacks in employable materials and final piece-part quality. Embodiments of the invention introduce two new classes of methods, solidification and trapping, to create complex and functional structures of macro/micro and nano sizes using configurable fields irrespective of whether they need a medium or not for transmission. Selective Spatial Solidification forms the piece-part directly within the selected build material whilst Selective Spatial Trapping injects the build material into the chamber and selectively directs it to accretion points in a continuous manner. In each a localized spatiotemporal concentrated field is established by configuring or maneuvering field emitters. These methods are suitable to create any 3D part with high mechanical properties and complex geometries. These layerless methods may be used discretely or in combination with conventional AM and non-AM manufacturing processes.

### CROSS-REFERENCE TO RELATED APPLICATIONS

This application claims the benefit of priority a 371 national phase application from Patent Cooperation Treaty patent application PCT/CA2018/000,023 filed Feb. 7, 2018 entitled “Methods and Systems for Additive Manufacturing” which itself claims benefit of priority from U.S. Provisional patent application 62/455,750 filed Feb. 7, 2017 entitled “Methods and Systems for Additive Manufacturing”, the entire contents of each being incorporated herein by reference.

### FIELD OF THE INVENTION

This invention relates to additive manufacturing and more particularly to additive manufacturing methods for creating layerless structures exploiting distributed localized field configurable selective techniques such as Selective Spatial Solidification (S³) and Selective Spatial Trapping (SST).

### BACKGROUND OF THE INVENTION

Ever since man began to fabricate things the dominant techniques over time have been those based upon selective material removal from a larger starting block of material. The exception being molding processes. Despite the evolution of tools over a few thousand years through the industrial revolution and a couple of hundred years of mechanization to the past few decades with computer numerical control (CNC) for increased precision the basic principle has remained the same. Namely, use something sharp and harder than the material being worked to remove it, leading to waste in not only the material employed but back through the supply chain to increased resources to get to that point.

However, during the past four decades a new trend of manufacturing has emerged, called additive manufacturing. In contrast to the old methods, additive manufacturing exploits materials that are added, commonly, layer by layer to form consecutive cross sections of the desired shape. Eliminating the waste is a significant advantage of additive manufacturing over subtractive manufacturing processes. Numerous methods have been utilized to implement the layer by layer material disposing within the prior art including laying photosensitive polymer and curing with UV focused beam, doctor blading a layer of metal powder and sintering by high power laser, or the deposition of melted polymer to shape the geometry. Such methodologies are depicted within the upper half of FIG. 6 as they all share something in common, namely the part is made layer-by-layer.

However, as depicted within the lower half of FIG. 6 there are presented a series of additive manufacturing methodologies that address several drawbacks within the prior art additive manufacturing processes including the limitations that prior art layer-by-layer/pixel-by-pixel additive manufacturing methods, commonly referred to as 3D printing, have in creating complex geometries, requiring post-processing and their tooling burdens. Accordingly, embodiments of the invention are geared to reducing manufacturing and post-processing times and costs and creating functional parts with controlled mechanical properties.

Over the past 30 years since the emergence of 3D printing and additive manufacturing (AM) concepts with their inherent layered process of solidification such processes have been very difficult and time consuming for building fully functional parts, especially metallic ones. In conventional laser assisted sintering AMs, structural imperfections arise by the method utilized to build up pixel-by-pixel layers which are therefore built in a non-continuous manner such that some inhomogeneity is inevitable. However, these voids and defect may potentially cause structural weakness by simply concentrating stress and initiating a fracture mechanism especially under dynamic loading. Further, poor surface quality through surface roughness is another drawback of aforementioned AM methods which may, independent of internal microstructure issues, trigger fatigue failure caused by surface crack propagation. In addition, warpage and deformation after solidification can significantly affect the final geometry of the part.

Within the prior art the importance of microstructure of parts was an issue and significant work has been directed to improving the mechanical properties of parts built by laser sintered AM. Laser scanning rate, laser power and layer thickness were investigated in order to optimize these processes. Despite these efforts, due to the layer-by-layer nature of the AM process, manufactured parts exhibit high porosity and as a result poor mechanical properties are obtained. Further, significant work within the prior art within the context of layer-by-layer AM has sought to address chronic issues such as warpage, curling, and porosity. For example, increased complexity such as heating cell mounted modular plates have been proposed to control the warpage and curling of parts by allowing the temperature of each cell to be independently controlled so that a localized temperature control system is implemented to selectively heat or cool each layer pixels to eventually achieve a less warped shape. However, very little prior art proposes novel AM methods that address these issues in a fundamentally different approach.

Examples of prior art techniques include exploiting electron beams to sinter the metal powder to achieve predefined surface topology, post process heat treatment processes, and laser processing. Laser frequency has been studied as it indirectly controls the microstructure of part via local temperature control. In other works secondary sintering is employed to reduce the porosity of the samples. However, despite this no prior art seeks to revamp the conventional layer-by-layer method such that all AM produced parts, especially metallic pieces, need excessive post processing operations to be functional.

More recently within the prior art the method of oxygen penetration assisted digital light processor (DLP) based AM has been demonstrated to provide decreased production time and improved mechanical properties for polymeric piece parts. The process exploits Continuous Liquid Interface Production (CLIP). However, the method can be only applied with polymers and still exploits cross section data of the designed parts.

Accordingly, it would be beneficial to provide AM processes that overcome these limitations within the prior art by providing parts formed with a layerless structure in contrast to prior art layer-by-layer 3D printed parts. Embodiments of the invention provide for parts that are sintered (in case of metal or ceramic powders) or polymerized and cured (in case of resin and polymers) in uniform and homogenous pattern resulting in homogenous structure and mechanical properties in comparison with parts manufactured by material removal or molding processes.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to additive manufacturing and more particularly to develop additive manufacturing methods for creating layerless structures exploiting distributed localized field configurable selective techniques such as Selective Spatial Solidification (S³) and Selective Spatial Trapping (SST).

In accordance with an embodiment of the invention there is provided a system for forming three-dimensional (3D) structures comprising:
a plurality of surfaces forming a predetermined portion of chamber, each surface comprising a plurality of discretized elements each emitting a predetermined signal;
a plurality of field sources each coupled to a subset of the plurality of discretized elements and each generating predetermined control signals of appropriate characteristics in dependence upon control data received from a control unit;
the control unit for generating the data provided to the plurality of field sources, wherein
the control data is generated in dependence upon model data relating to a 3D model of a 3D structure to be formed and material data relating to a build material from which the 3D structure will be formed.

In accordance with an embodiment of the invention there is provided a method of forming three-dimensional (3D) structures comprising:
providing a system comprising
   a plurality of surfaces forming a predetermined portion of a chamber, each surface comprising a plurality of discretized elements each emitting a predetermined signal;
   a plurality of field sources each coupled to a subset of the plurality of discretized elements and each generating predetermined control signals of appropriate characteristics in dependence upon control data received from a control unit;
   the control unit for generating the data provided to the plurality of field sources;
providing a build material within a predetermined portion of the chamber; and
providing the control data, wherein the control data is generated in dependence upon model data relating to a 3D model of a 3D structure to be formed and material data relating to a build material from which the 3D structure will be formed.

In accordance with an embodiment of the invention there are provided computer executable instructions stored upon a non-volatile non-transitory storage medium, the executable instructions when executed by a microprocessor executing a method comprising:
receiving model data relating to a three-dimensional (3D) model of a 3D structure to be fabricated by an additive manufacturing process;
receiving material data relating to a build material from which the 3D structure will be formed using the additive manufacturing process;
establishing in dependence upon the model data and material data control data relating to a plurality of field sources each coupled to a subset of a plurality of discretized elements forming a predetermined portion of a system supporting the additive manufacturing process; wherein
the control data causes each of the plurality of field sources to generate predetermined control signals of appropriate characteristics to drive each of the subset of the plurality of discretized elements to emit a predetermined signal relating to fabricating the 3D structure with the build material.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIGS. 1A and 1B depict schematic views of a Selective Spatial Solidification configuration of additive manufacturing according to an embodiment of the invention;

FIGS. 2A to 2C depict a schematic view of a Selective Spatial Solidification process configuration of additive manufacturing according to an embodiment of the invention;

FIGS. 3A to 3C depict an exemplary system configuration and process sequence for an additive manufacturing process according to an embodiment of the invention exploiting Selective Spatial Solidification (S³) process;

FIG. 4 depicts schematically different configurations for the workspace within additive manufacturing systems according to embodiments of the invention exploiting Selective Spatial Trapping (SST) process;

FIGS. 5A to 5C depict schematically a Selective Spatial Trapping (SST) configuration of additive manufacturing according to an embodiment of the invention;

FIG. 6 depicts schematically the hierarchal structure underlying prior art additive manufacturing and additive manufacturing methodologies according to embodiments of the invention;

FIGS. 7 and 8 depict exemplary process flow charts for field configurable additive manufacturing systems according to embodiments of the invention;

FIGS. 9A to 9C depict exemplary two-dimensional (2D) and three-dimensional (3D) work spaces for a field configurable additive manufacturing system according to embodiments of the invention with different element geometries and configurations;

FIGS. 10A and 10B depict an exemplary chamber structure for field configurable three-dimensional (3D) additive manufacturing systems according to embodiments of the invention and a 3D CAD model of a piece-part to be formed;

FIGS. 11A to 11C depict an exemplary chamber structure and process sequence for field configurable additive manufacturing system according to an embodiment of the invention together with its Field Focal Zones (FFZs) final piece part after sintering;

FIG. 12 depicts a schematic depicting FFZs within a piece part during a field configurable additive manufacturing system that are tangential to the surface of the piece part;

FIGS. 13A and 13B depict exemplary two-dimensional (2D) and three-dimensional (3D) work spaces for a field configurable additive manufacturing system according to embodiments of the invention;

FIGS. 14A and 14B depict computer simulation results for an exemplary case study (Case Study I) exploiting a field configurable AM according to an embodiment of the invention;

FIG. 15 depicts multiple particle release simulations within an exemplary field configurable AM system according to an embodiment of the invention for Case Study I to form a straight line;

FIGS. 16A and 16B depict computer simulation results for an exemplary case study (Case Study II) exploiting a field configurable AM according to an embodiment of the invention;

FIGS. 17A and 17B depict computer simulation results for an exemplary case study (Case Study III) exploiting a field configurable AM according to an embodiment of the invention;

FIG. 18 depicts multiple particle release simulations within an exemplary field configurable AM system according to an embodiment of the invention for Case Study I to form a straight line;

FIG. 19 depicts creating a 3D piece part within a 3D chamber with an exemplary field configurable AM system according to an embodiment of the invention for Case Study I to form a straight line;

FIG. 20 depicts a schematic view of the prototype apparatus and a two-dimensional (2D) axisymmetric model of the apparatus;

FIG. 21 depicts the pressure level distribution of the prototype apparatus depicted in FIG. 20 from simulation;

FIG. 22 depicts the simulated acoustic pressure of the prototype apparatus depicted in FIG. 20 from simulation arising from the induced pressure distribution depicted in FIG. 21;

FIG. 23 depicts the acoustic intensity along the z-axis of the transducer derived by simulation; and

FIG. 24 depicts the transient temperature at the center of the focal region of the simulated prototype apparatus indicating that the temperature is stabilized after about 40 seconds at 80° C. with a peak induced temperature increase of 100° C. within the initial 40 second from initiating the sonication.

### DETAILED DESCRIPTION

The present invention is directed to additive manufacturing and more particularly to additive manufacturing methods for creating layerless structures exploiting distributed localized field configurable selective techniques such as Selective Spatial Solidification (S³) and Selective Spatial Trapping (SST).

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users. Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List of file formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request; said request may be a query, a search, a trigger, an alarm, and a message for example.

A “CAD model” as used herein may refer to, but is not limited to, an electronic file containing information relating to a component, piece-part, element, assembly to be manufactured. A CAD model may define an object within a two-dimensional (2D) space or a three-dimensional (3D) space and may in addition to defining the internal and/or external geometry and structure of the object include information relating to the material(s), process(es), dimensions, tolerances, etc. Within embodiments of the invention the CAD model may be generated and transmitted as electronic content to a system providing manufacturing according to one or more embodiments of the invention. Within other embodiments of the invention the CAD model may be derived based upon one or more items of electronic content directly, e.g. a 3D model may be created from a series of 2D images, or extracted from electronic content.

A “fluid” as used herein may refer to, but is not limited to, a substance that continually deforms (flows) under an applied shear stress. Fluids may include, but are not limited to, liquids, gases, plasmas, and some plastic solids.

A “powder” as used herein may refer to, but is not limited to, a dry, bulk solid composed of a large number of very fine particles that may flow freely when shaken or tilted. Powders may be defined by both a combination of the material or materials they are formed from and the particle dimensions such as minimum, maximum, distribution etc. A powder may typically refer to those granular materials that have fine grain sizes but may also include larger grain sizes depending upon the dimensions of the part being manufactured, the characteristics of the additive manufacturing system etc.

A “metal” as used herein may refer to, but is not limited to, a material having good electrical and thermal conductivity. Metals are generally malleable, fusible, and ductile. Metals as used herein may refer to elements, such as gold, silver, copper, aluminum, iron, etc. as well as alloys such as bronze, stainless steel, steel etc.

A “resin” as used herein may refer to, but is not limited to, a solid or highly viscous substance which is typically convertible into polymers. Resins may be plant-derived or synthetic in origin.

An “insulator” as used herein may refer to, but is not limited to, a material whose internal electric charges do not flow freely, and therefore make it nearly impossible to conduct an electric current under the influence of an electric field.

A “ceramic” as used herein may refer to, but is not limited to, an inorganic, nonmetallic solid material comprising metal, non-metal or metalloid atoms primarily held in ionic and covalent bonds. Such ceramics may be crystalline materials such as oxide, nitride or carbide materials, elements such as carbon or silicon, and non-crystalline.

A “polymer” as used herein may refer to, but is not limited to, is a large molecule, or macromolecule, composed of many repeated subunits. Such polymers may be natural and synthetic and typically created via polymerization of multiple monomers. Polymers through their large molecular mass may provide unique physical properties, including toughness, viscoelasticity, and a tendency to form glasses and semi-crystalline structures rather than crystals.

A “discretized element” as used herein may refer to, but is not limited to, an element creating an emitted signal within an additive manufacturing (AM) system according to or exploiting one or more embodiments of the invention. A discretized element may refer solely to that portion of each element generating the emitted signal, e.g. a transducer, or it may refer to the element generating the emitted signal together with part or all of the associated control and drive circuitry receiving control data, processing the control data, and generating the appropriate drive signal(s) to the element generating the emitted signal. A discretized element may generate an emitted signal selected from the group comprising infrared (IR) radiation, visible radiation, ultraviolet (UV) radiation, microwave radiation, radio frequency (RF) radiation, X-ray radiation, electron beam radiation, an ultrasonic signal, an acoustic signal, a hypersonic signal, a magnetic field and an electric field. Whilst a discretized element may refer to a single emitted signal type other discretized elements may emit multiple signals. The physical dimensions of a discretized element may vary according to the dimensions of the AM system they form part as well as the number of discretized emitters within the AM system. Accordingly, discretized elements may be pico-elements having dimensions defined in picometers (10⁻¹² m) or Angstroms (10⁻¹⁰ m), nano-elements having dimensions defined in nanometers (10⁻⁹ m), micro-elements having dimensions defined in micrometers (10⁻⁶ m), as well as elements having dimensions defined in millimeters (10⁻¹² m), centimeters (10⁻² m), meters (10⁰ m) and decameters (10¹ m).

A: Background

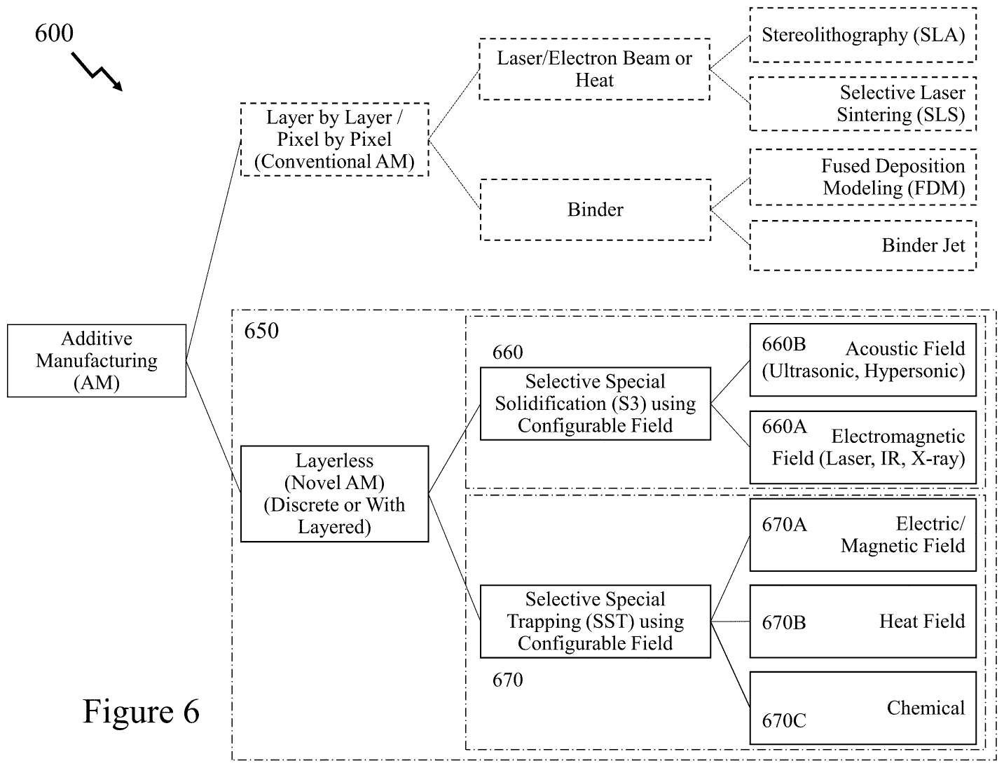

As depicted in the lower half of FIG. 6, the inventors present a new hierarchy of additive manufacturing (AM) techniques that present layerless or layerless-layered AM techniques. As depicted there are two novel branches of additive manufacturing which the inventors refer to as Selective Spatial Solidification (SSS or S³) and Selective Spatial Solidification Trapping (SST). Each of these new methods utilize a controllable field either with a medium for field transmission, for example ultrasonic field based AM, or without a medium for field transmission, such as within laser, infra-red, X-ray, electrical, magnetic, etc. field based AMs. Within the Selective Spatial Solidification (S³) method, the field is focused selectively in the workspace, which is filled with powders or polymers for example, of the Additive Manufacturing System (AMSys) to locally increase the local temperature of the filler material or initiate polymerization in polymers for example. The locations and shapes of the focused regions are maneuvered and manipulated inside the AMSys filled with the required material for the part.

Accordingly, embodiments of the invention solve limitations of additive manufacturing methods, e.g. 3D printing, and tooling burdens in creating complex geometries with less manufacturing time and post-processing and controllable mechanical properties. Within the Selective Spatial Trapping (SST) method, the work chamber within the AMSys is empty at the beginning of the process. Then, powder particles are released into the chamber wherein discretized elements on the surface of the chamber apply controlled electric/magnetic fields to trap these particles in specific regions inside the workspace of the chamber and form the part.

Whilst porosity in AM produced parts is a negative issue in the aerospace and automobile industries and generally in classical mechanical engineering fields, in some other areas such as bioengineering, controlled porosity is a desired characteristic of the produced structures such as implants and artificial tissues for example. Within embodiments of the invention, the inventors provide for control of the porosity quality and quantity of the pores within the structure of the produced part by providing adjustable parameters of the AM process such as dynamically varying or statically defining the pressure of the work chamber and also the intensity of the applied field.

According to embodiments of the invention, the inventors present a new concept in AM which they refer to as “layerless” which is depicted as the lower half (Layerless 650) of the AM processing hierarchy 600 depicted in FIG. 6. The “layerless” may be employed, as will become evident within the descriptions below, as the sole AM process or it may be employed in conjunction with a “layered” AM process as known within the prior art. Accordingly, discrete layerless (single layerless process), multi-layerless (two or more layerless processes), layerless-layered (single layerless), multi-layerless-layered (two or more layerless processes with layered process), layerless-multi-layered (layerless with two or more layered processes) and multi-layerless-multi-layered (two or more layerless processes with two or more layered processes) may be implemented using techniques, processes, and methods according to embodiments of the invention.

As depicted the Layerless 650 processing is further split into two novel classes of methods which each introduce new concepts in additive manufacturing. The first class is Selective Spatial Solidification (S³ or S3) 660 using Configurable Fields. Within S3 Layerless processes an applied field is focused at a desired location within a processing chamber filled with a powder or fluid of the material to be employed in the current step or steps of the AM processing. These focal regions are created in predetermined locations inside the processing chamber to solidify the filled material inside the processing chamber selectively. Solidification may for example, occur when the focused field interacts with powder(s), a coating of the powder(s), liquid, fluid, polymer etc. These interactions may, within a subclass Electromagnetic Fields 660A, be via sintering or heat curing due to temperature increase for example through infrared (IR) light, visible light, ultraviolet (UV), microwaves, radio frequency (RF), X-ray or electron beam excitation for example. Also depicted is subclass Acoustic Fields 660B such as ultrasonic, acoustic, and hypersonic for example. The focused field is directed/generated/maneuvered inside the processing chamber by controlling active discretized elements which are responsible for applying the field(s).

The second class is Selective Spatial Trapping (SST) 670 wherein particles released into the processing chamber are trapped at the desired location inside the processing chamber to create required geometry. Within a subclass Electric/Magnetic Field(s) 670A is(are) configured within the processing chamber such that the powder particles are manipulated, placed and held in specific locations to shape the required geometry of the physical object. The electric/magnetic field may be uniform or non-uniform and may be tuned precisely based on the requirements of the geometry. Depending upon the environment within the processing chamber no subsequent processing may be required whilst in others post-formation fusing, in sub-class Heat Field 670B, may be exploited to fuse elements together using a heat source. Alternatively, in sub-class Chemical 670C a chemical reaction may be initiated with the layerless deposited material(s) to provide the fusing of the materials into a rigid piece-part.

Each of the classes S3 660 and SST 670 with their respective sub-classes may be exploited in each of the discrete layerless (single layerless process), multi-layerless (two or more layerless processes), layerless-layered (single layerless), multi-layerless-layered (two or more layerless processes with layered process), layerless-multi-layered (layerless with two or more layered processes) and multi-layerless-multi-layered (two or more layerless processes with two or more layered processes) methodologies. Optionally, the piece-part(s) formed in the layerless process(es) may be post-processed prior to another layerless and/or layered process or terminating. Within the S3 660 class methods the piece-part is manufactured in two different ways wherein (i) the entire part is focused with the excitation fields from inside to outside and further solidified whereas alternatively (ii) only the outer surface of the part is exposed to the excitation fields and solidified. When the target of the focused field is the geometrical envelope of the part, the initial material (e.g. powder) envelope is solidified and consequently produces the shell replica of the part filled with unprocessed material (e.g. the powder). When the outer solidified part is removed from the chamber the excessive powders which were not solidified may be removed through an opening within the piece-part. For example, with metallic powders the final hollow piece-part (or shelled part) may be transferred to a thermal processing environment, e.g. furnace, for final sintering to produce entire part or alternatively, the processing chamber is emptied whilst the piece-part is maintained in position and the processing chamber executes a sintering or thermal processing cycle.

B: Selective Spatial Solidification (S3) Method

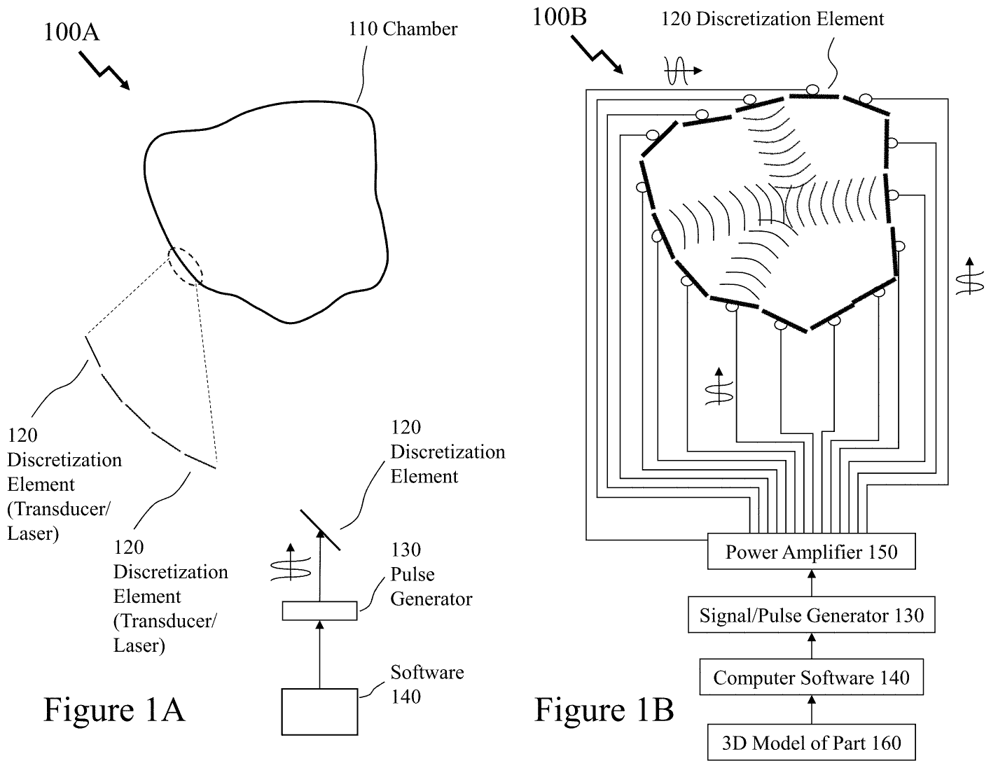

Now referring to FIGS. 1A and 1B respectively there are depicted first and second schematic views 100A and 100N respectively of a processing chamber 110 (workspace) and the detail of the surface of the processing chamber 110. The chamber surface is discretized with a plurality of discretized elements (chamber discretizations which may be, for example micro-transducers also known as micro-elements) 120 which are each a field source. For example, the discretized elements 120 may be piezoelectric transducers (in case of acoustic field layerless processing) to support sub-class Acoustic Fields 660A or electromagnetic emitters (in cases of laser, IR and X-ray etc.) to support sub-class Electromagnetic Fields 660B. As depicted in FIG. 1A the created field from the discretized elements 120 is controlled by a pulse (signal) generator 130 which are driven under control of software 140. Alternatively, as depicted in FIG. 1B the discretized elements 120 are connected to signal/pulse generators 130 via power amplifiers 150. The computer software 140 calculates the desired field at each coordinate of the chamber 110 (workspace) and commands the pulse generators 130 to activate the micro-elements 120 to generate the required field. The computer software 140 establishing the geometry of the piece-part in response of a three-dimensional (3D) model 160 of the piece-part.

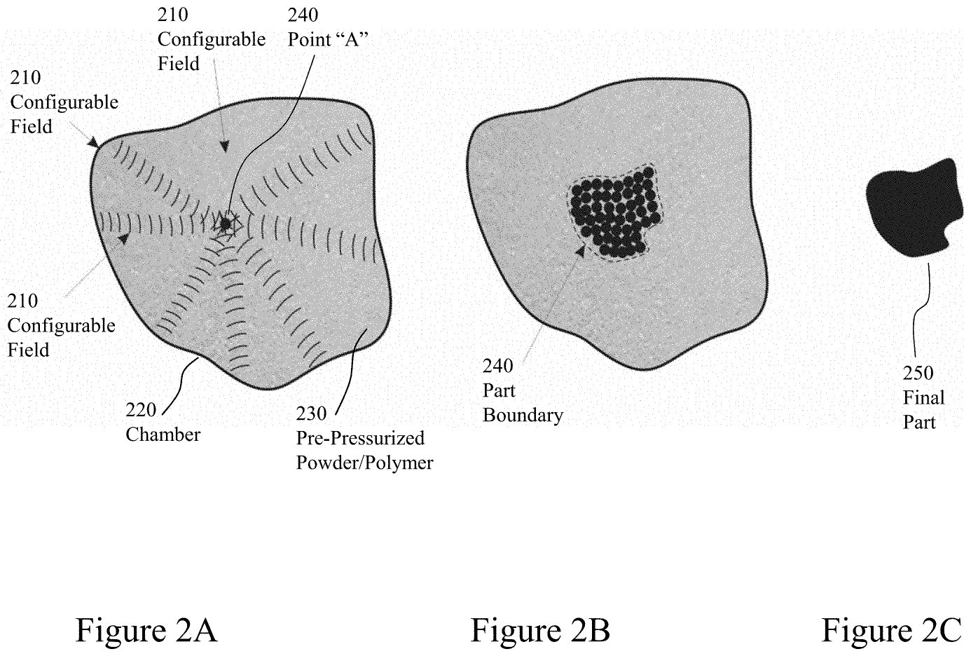

Referring to FIGS. 2A to 2C respectively depict schematic views of a Selective Spatial Solidification process configuration for additive manufacturing according to an embodiment of the invention wherein the chamber may be filled with materials such as metal and/or ceramic powders or heat sensitive polymer, for example although other materials may be employed if they achieve the desired characteristics under excitation and subsequent processing. Optionally, powders may be coated with heat sensitive coatings, chemical coatings, etc. For example, in FIG. 2A a point A 240 inside the chamber of pre-pressurized powder/polymer 230 needs to be solidified (point A can be inside or on the outside surfaces of the part). Then, the software calculates the required field configurations, for example in this instance ultrasonic, to focus the ultrasonic fields generated by the discretized elements at desired locations based on geometry of the part and increase the temperature at point A 240 thereby solidifying the coating of the powders or powders at that location. The activated discretized elements (in this case the transducers), send ultrasonic waves (configurable field 210) targeted at point A 240 within the chamber 220. When the ultrasonic waves reach the point A 240, they are focused and combine to create acoustic pressure at point A 240 and the temperature at this region is increased and the thermoset coating of the powders or powder is solidified thus creating a localized locations of the solidified powders in the chamber 220 in that region. In this manner, the rest of the interior or boundary of the desired part is solidified accordingly to create the final geometry of the part as depicted in FIG. 2B with part boundary 240. Subsequently, the chamber 220 is opened, the excess powder is removed, and the solidified piece-part 250 is cleaned as depicted in FIG. 2C. The solidified final part 250 may then be exposed to post-processing such that thermal processing to sinter the metal powders and create a solid part.

In the aforementioned process, temperature increases are applied to affect only localized zones of the part or of the outer shell of the part. However, it is possible to create such a field to increase the temperature to a limit that the powders themselves are sintered inside the chamber rather than requiring post-processing in a second element of manufacturing equipment. If the powders are sintered inside the chamber, there is no need to transfer the part to the furnace to further sinter the powders except in the case of outer shell approach. Optionally, rather than temperature forming the final bonding process the materials initially bonded within the S3 process are processed by either the same applied field methodology but at different conditions or another layerless sub-class of processing is applied. For example, with acoustic consolidation of powder particles to form a piece-part a subsequent higher energy acoustic processing sequence may further consolidate and bind the powders.

Alternatively, one or more of the other S3 or SST processes may be applied discretely or in combination with other manufacturing processes as known within the art. For example, the piece-part may be embedded within another material, e.g. a fluid, and hypersonic acoustic excitation employed. Alternatively, visible, infrared irradiation may be employed to raise the piece-part temperature whilst chemical processes may be triggered to bind or support subsequent processes such as, for example, catalyst triggered nucleation/deposition onto the piece-part such that the piece-part formed provides a template for another 3D AM process.

Despite existing 3D printing technologies (upper half of FIG. 6) in which existence of earth gravity is essential in creating 3D structures, S3 or SST processes are independent on gravity. Hence, S3 or SST processes can be used in zero gravity condition in space.

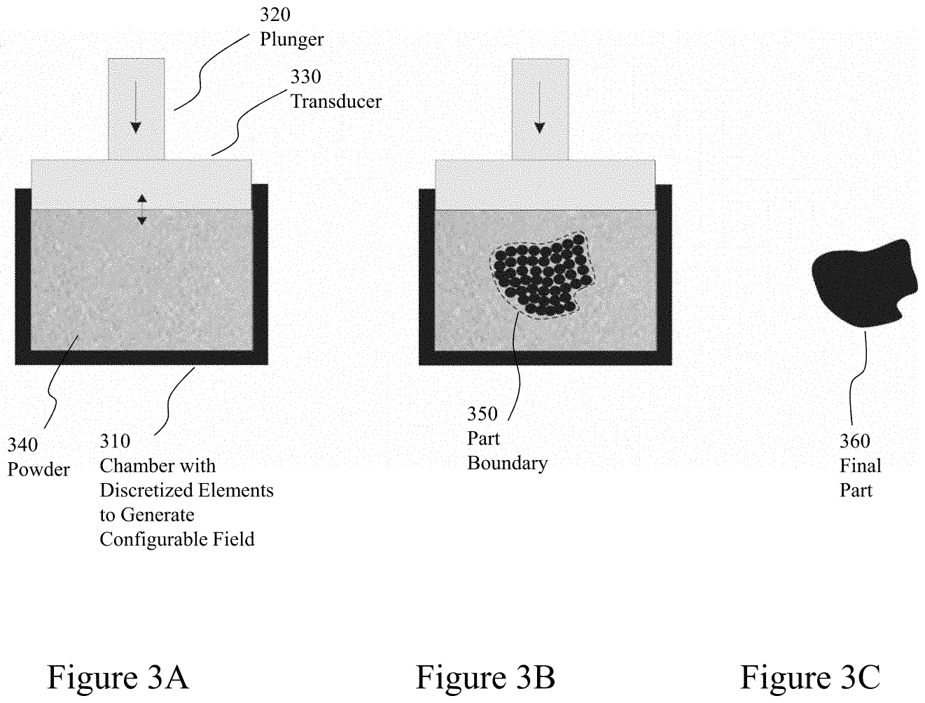

Within the embodiments of the invention, with the exploitation of powders, particulates, etc. rather than fluids or fluid mixtures it may be beneficial to control the level of the porosity of the part structure, e.g. biological implantation piece-parts, micro-catalytic reactors, etc. Accordingly, within an embodiment of the invention the powder(s) inside the chamber may be pressurized to achieve an acceptable density/low porosity of the part. The conventional AM machines lack this kind of pressure to compact the powders. Referring to FIGS. 3A to 3C there is depicted an exemplary system configuration and process sequence for an additive manufacturing process according to an embodiment of the invention exploiting a Selective Spatial Solidification process. Accordingly, as depicted in FIG. 3A the chamber 310, with its discretized elements to generate the configurable fields, is filled with powder 340 atop which is a transducer 330 and a plunger 320. Accordingly, the combination of the transducer 330, e.g. ultrasonic, and the plunger 320 execute a predetermined sequence of vibratory agitations and mechanical compressions to compact the powder 340. The excitation of the discretized elements to generate the configurable field(s) as depicted in FIG. 3B generates the formation of the part boundary 350 and after completion of the processing sequence as depicted in FIG. 3C the finished piece-part 360 is retrieved from the chamber 310.

Optionally, the chamber 310 may be evacuated to remove air and/or flushed—filled with a predetermined fluid that may, for example, aid formation of the part, prevent adverse reactions, and be included within closed pores within the finished piece-part. For example, filling with an inert gas would prevent any reactions with the oxygen in air when the piece-part is heated. Alternatively, evacuating to a predetermined vacuum level would result in any enclosed voids being vacuum. In addition to adjusting the AM process the use of a vacuum and/or fluid may aid establishment of the required density within the compact powders thereby in producing high quality functional mechanical parts absent micro-structures or with homogeneous micro-structures. Processing without the same degree of compaction may provide micro-structures of varying dimensions.

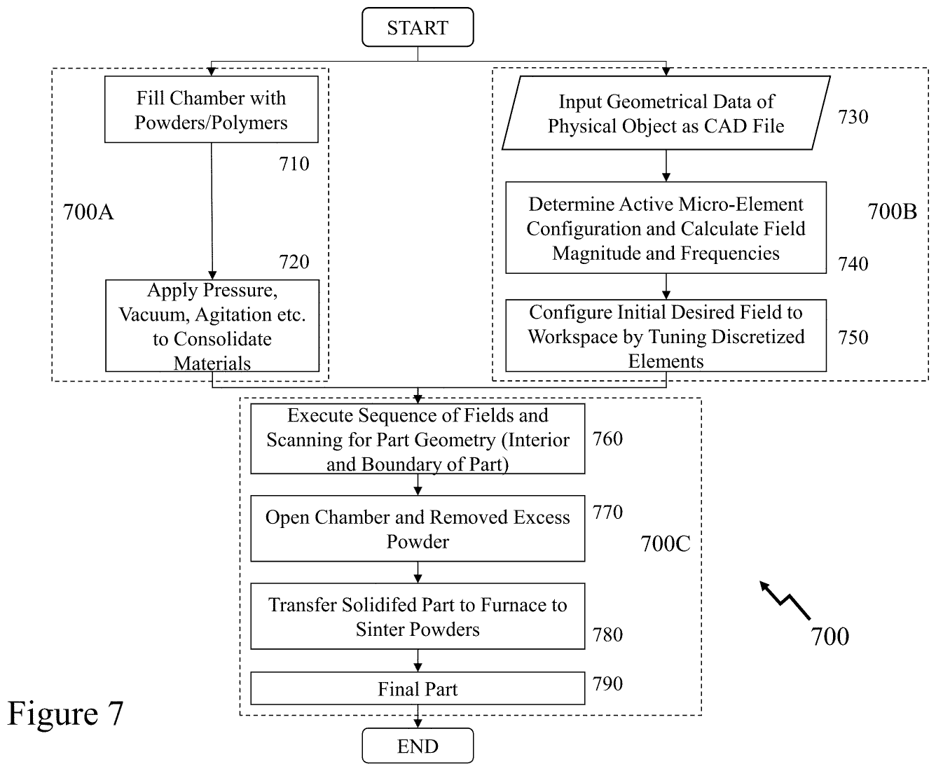

Referring to FIG. 7 there is depicted an exemplary process flow 700 for an S3 AM process comprising first and second parallel processes 700A and 700B before the process 700C is executed. Accordingly, first parallel process 700A comprises:
Step 710—Fill processing chamber with powders/polymers etc. which will form the piece-part and/or provide the appropriate conditions; and
Step 720—Apply required mechanical pressure, agitation, vacuum etc. required to consolidate the materials to the required level.

Second parallel process 700B comprises:
Step 730 wherein the geometrical data of the physical object is input as a CAD file (wherein the data relating to the S3 processing may form one or more layers within the CAD file and one or more objects within the CAD file);
Step 740 wherein the S3 system software determines the active discretized element configuration and calculates the required discretized element field magnitudes and frequencies; and
Step 750 wherein the S3 system establishes the initial desired field within the chamber.

Accordingly, Process 700C comprises:
Step 760 wherein the S3 system executes the required sequence of applied fields and scanning to establish the part geometry, e.g. interior and/or boundary of part(s);
Step 770 wherein upon completion the chamber is opened and excess material, e.g. powder, removed;
Step 780 wherein the finished piece-part is transferred to a furnace to sinter the powder; and
Step 790 wherein the final part is ready.

It would be evident that optionally, step 780 may be replaced with an apply sintering process within the chamber where the discretized elements or a second set of discretized elements support the sintering process

C: Selective Spatial Trapping (SST) Method

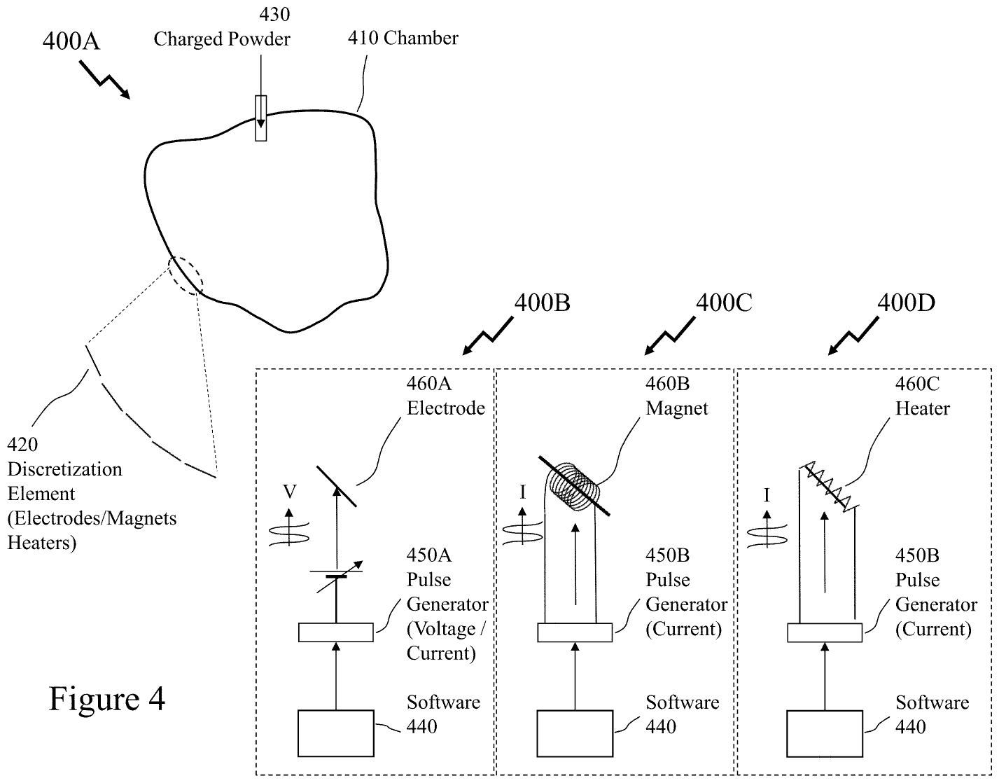

Now referring to FIG. 4 there is depicted a first schematic 400A of a processing chamber 410 according to an embodiment of the invention supporting the Selective Spatial Trapping (SST) AM process according to embodiments of the invention. Accordingly, controlled fields are generated within the workspace of the chamber 410 through discretization elements 420 across the inner surface of the chamber 410. Each discretization element 420 such as micro-electrodes 460A in second schematic 400B, micro-magnets 460B in third schematic 400C, and micro-heaters 460C in fourth schematic 400D, is controlled by a controlling system which is executing control software 440. As depicted within second to fourth schematics 400B to 400D the software 440 provides control signals to driving circuits, namely Pulse Generator (Voltage/Current) 450A and Pulse Generator (Current) 450B, which then provide the appropriate drive signals to the discretized elements 420. Also depicted in first schematic 400A is inlet for the charged power 430.

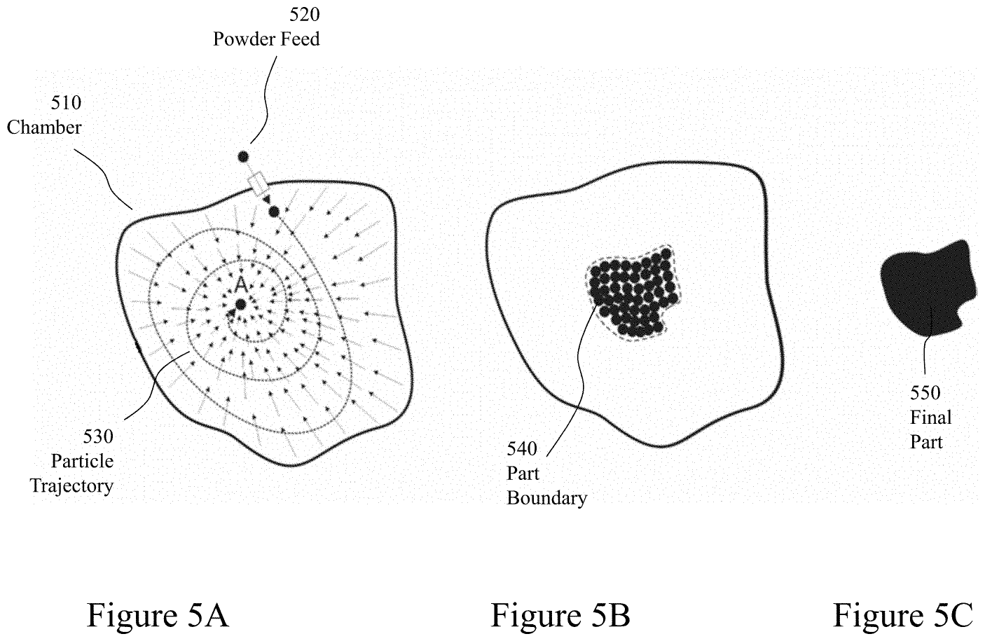

Accordingly, as with the S3 methodology, the 3D computerized model of the designed part is analyzed by the software 400 and varying fields applied by the discretized elements are calculated in such a way that the field in the interior regions of the part transiently equalized to force the fed powders to be gathered into desired regions of the piece-part, which the inventors refer to as called “settled regions”. This process being depicted in FIGS. 5A to 5C respectively. Accordingly, as depicted in FIG. 5A a powder feed 520 is coupled into the chamber 510 wherein through the influence of the applied fields within the chamber 510 the powder “guided” to point “A” (the current settle region). The powder 520 may be charged or uncharged particles, coated or uncoated particles, metallic or non-metallic powder, polymeric powder, ceramic powder etc. discretely or sequentially released into the chamber. The particles “automatically” gather in the settled regions (the interior and boundaries of the part) through the action of the applied fields either continuously or periodically applied or continuously applied and time-varying. Once, the process has “settled” (accreted) the desired material(s) in the desired geometry/geometries then the part is processed using other AM and/or non-AM manufacturing processes to establish the final piece part.

For example, the piece-part may be infrared illuminated to heat it, a chemical fluid maybe introduced to react with a particle coating or catalyze a reaction, or a binder agent introduced. The part may be post-processed in situ, within another chamber via automated transfer or different processing system completely. For example, a piece-part exposing to a binding fluid may be transferred to a furnace for sintering. The final produced part, after the sintering process in the furnace, will accordingly have the desired mechanical properties for a functional mechanical component. In other words, embodiments of the invention provide a manufacturing process that is mold-less metallurgy powder based. Without using a mold, the powder particles are gathered in the desired regions to create the geometry of the part and then the part is mounted in the furnace for sintering process. Accordingly, re-entrant geometries that cannot be molded today without requiring destruction of the mold can be formed and the parts exploiting metallic cross-sections that vary in a controlled manner due to the selective addition—deposition (accretion) process or have different alloy compositions in different locations. Further, inserts of one metal may be made directly during manufacturing without requiring subsequent processing.

Further, by varying the applied fields within the workspace and the accretion locations allows the designer to form parts with a capability to compact the powders to avoid any porosity inside the structure of the part or engineer the porosity to a desired level. As inventive method does not use any layer(s) process, therefore, homogenous mechanical properties of the part can be established. Alternatively, non-homogenous mechanical properties can be established with a graduation-definition-location etc. that cannot be achieved with convention manufacturing processes without multiple molding/casting processes with or without additional milling/drilling/machining. For example, a copper core can be formed between stainless steel casing with complex 3D geometry in single manufacturing sequence. The produced parts can compete with the parts produced by machining or molding process in terms of mechanical properties and functionality. Further, as production time in the present method in lower than the conventional additive manufacturing using layer-by-layer concepts (where these are actually available) then the layerless AM process is expected to further offer lower costs and higher throughputs.

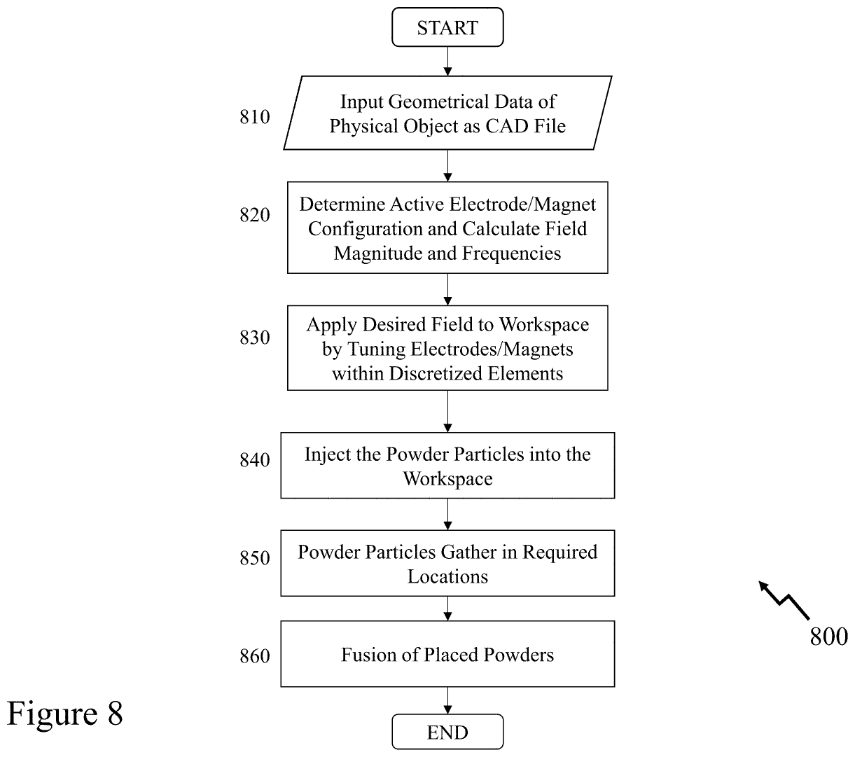

Referring to FIG. 8 there is depicted an exemplary process flow 800 for an SST layer less AM process. Accordingly, as depicted the process flow 800 comprises the steps:
Step 810 wherein the CAD file of the part geometry is loaded to the software controlling the SST AM processing system together with material data either within the CAD file or secondary datafile;
Step 820 wherein the software controlling the SST AM processing system determines the configurations, field magnitudes, frequencies and temporal sequences of these in dependence upon the CAD geometry data and the materials being accreted;
Step 830 wherein the software controlling the SST AM processing system applies the required configurations, field magnitudes, frequencies etc.;
Step 840 wherein the powder particles are injected into the chamber;
Step 850 wherein the power particles are gathered/accreted into the desired geometry through the SST AM processing system; and
Step 860 the piece-part powders accreted are fused together.

It would be evident to one of skill in the art that the exemplary process flow 800 may be varied to support other AM processes such as, for example, supporting sequential deposition of different powders through a loop involving all or a subset of steps 810 to 850 respectively or that the step 840 may involve the injection of a time varying powder composition controlled by the overall system in response to the CAD file and driving the discretized elements appropriately.

D: Selective Spatial Solidification (S3) Method

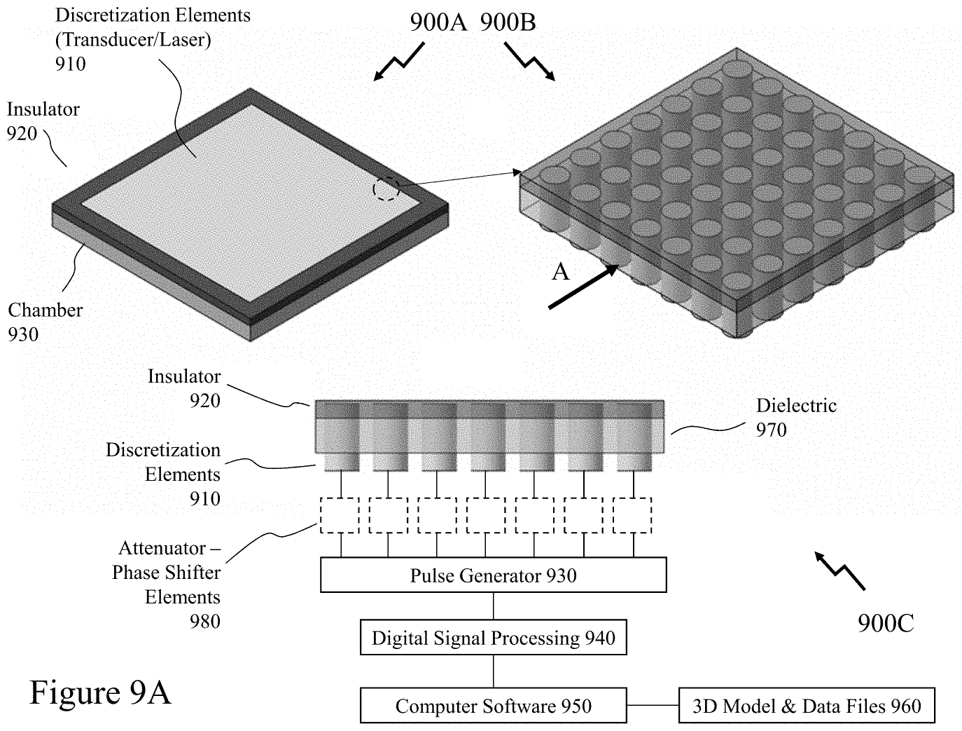

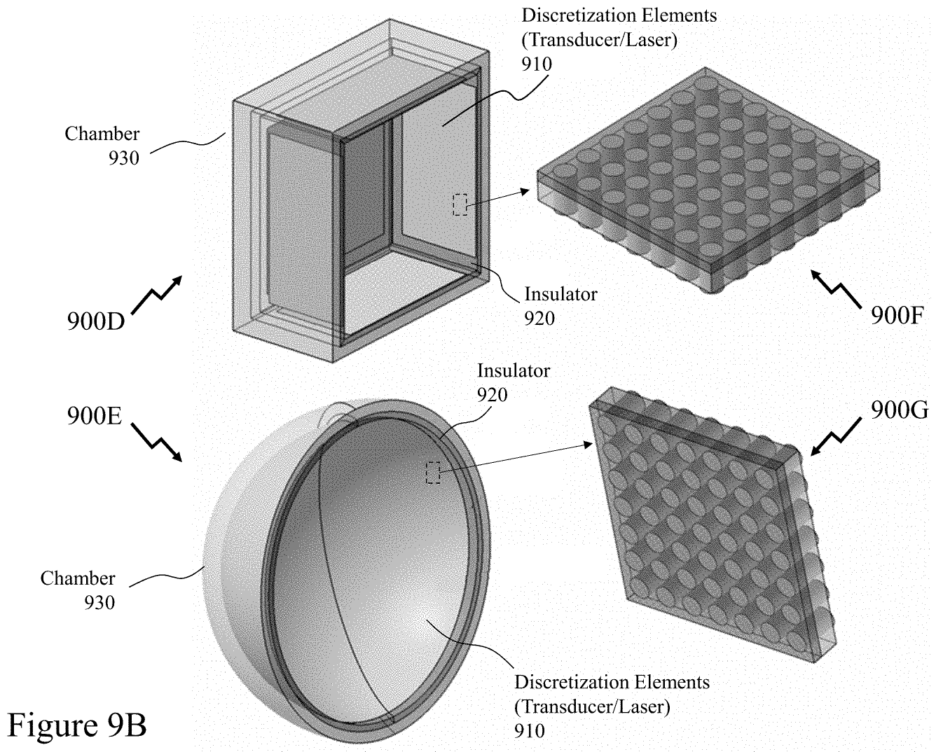

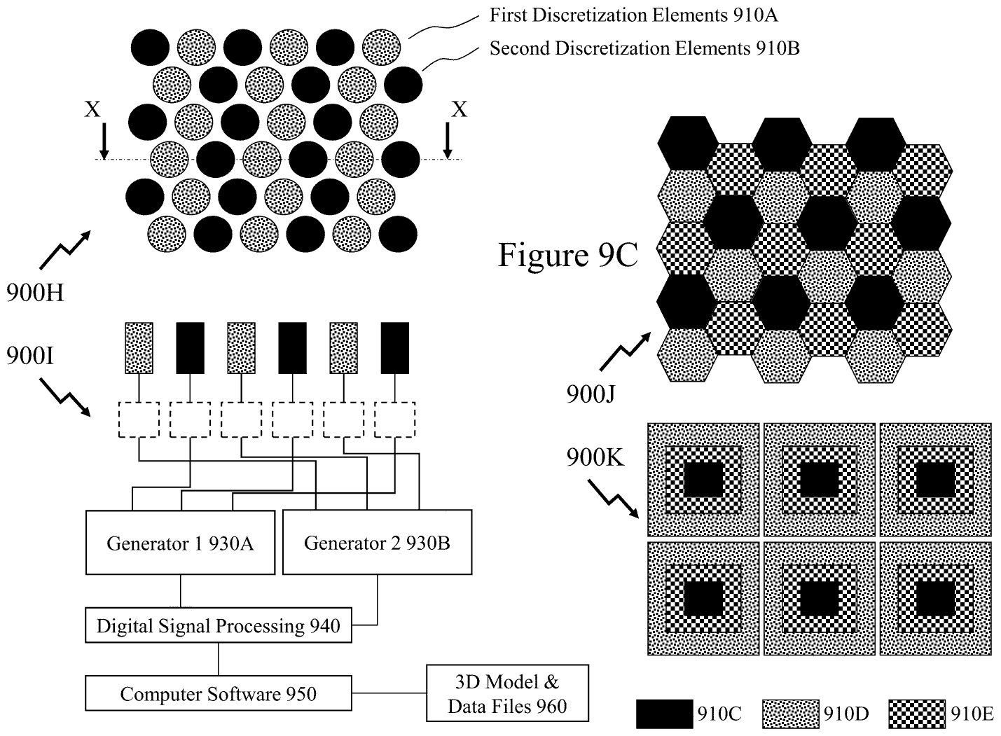

As described and discussed supra in respect of FIGS. 1A to 2C respectively the inner surfaces of the S3 AM processing chamber are covered with discretized element arrays as depicted within FIGS. 9A and 9B to create the desired field, which may be uniform, focused, defocussed, etc., within the chamber in the presence of the pressurized powders or polymers. Referring to FIG. 9A and first image 900A the discretized elements 910 are depicted as disposed upon an insulator 920 upon the body of the chamber 930. The discretized elements 910 being depicted an in enlarged view 900B wherein it is evident that the surface of the insulator 920 is covered with a large number of discretized elements 910. These as depicted in third view 900C along direction “A” in enlarged view 900B may be embedded within a dielectric 970. The discretized elements 910 are coupled to the Pulse Generator 930 (or alternate driving means) via optional Attenuator—Phase Shift Elements 980 according to the type of discretized element 910 implemented. The Pulse Generator 930 is coupled to Digital Signal Processing 940 which takes the data stored within the Computer Software 950 derived in dependence upon the 3D Model & Data Files 960 which define the geometry, material, etc.

As depicted in FIG. 9A the discretized elements 910 are formed upon a planar surface and may provide an implementation of the active field generator structure within an S3 AM system according to an embodiment of the invention for some piece-part manufacturing. However, referring to FIG. 9B there are depicted first and second AM systems 900D and 900E in rectangular chamber and spherical chamber configurations respectively. Each may represent the full active field generator section of an AM system or it may alternatively represent part with a second mirror assembly providing an enclosed chamber that may be split for maintenance, cleaning, part removal etc. in some embodiments of the invention although it is evident that other configurations may be implemented without departing from the scope of the invention. Each chamber 930 employs arrays of discretized elements 910 as depicted in first and second tiles 900F and 900G respectively which compose each surface of the inner chamber wall. As depicted the tiles 900F and 900G have the same structure as that depicted and discussed in respect of FIG. 9A with enlarged view 900B and third image 900C. However, it would be evident that in any of the configurations depicted in FIGS. 9A and 9B respectively that according to the design and requirements of the system that the tiles may be planar, non-planar, portions of a predetermined geometrical shape (e.g. portions of a spherical surface), etc.

Optionally, the tiles as depicted in FIG. 9C in first and second images 900H and 9001 respectively be comprised to two different discretized elements, first discretized elements 910A and second discretized elements 910B, which are each coupled to different generators, Generator 1 930A and Generator 2 930B, and therein to the Digital Signal Processing 940, etc. It would also be evident that the discretized elements may be used with other configurations with 3, 4 or more different functionalities using different geometrical configurations such as within first image 900H and third image 900J which are hexagonally packed or fourth image 900K wherein they are nested at each site within a rectangular grid. Accordingly, multiple geometries, multiple discretized element designs, and multiple packing configurations may be employed cross the entire chamber or these may vary within different regions of the chamber.

Each discretized element is activated to create a field by a pulse generator which creates voltage or current pulses. The activation pattern of the discretized elements and the type of the pulse is calculated by the software which analyzes the 3D geometry of the part and calculates the required field. The filed is calculated in such a way that the interior and boundaries of the part are solidified selectively. The digital signal processing unit generates the voltage information to create the field. The numerical calculations required to activate the electrodes are performed from the desire 3D model of the structure to be manufactured.

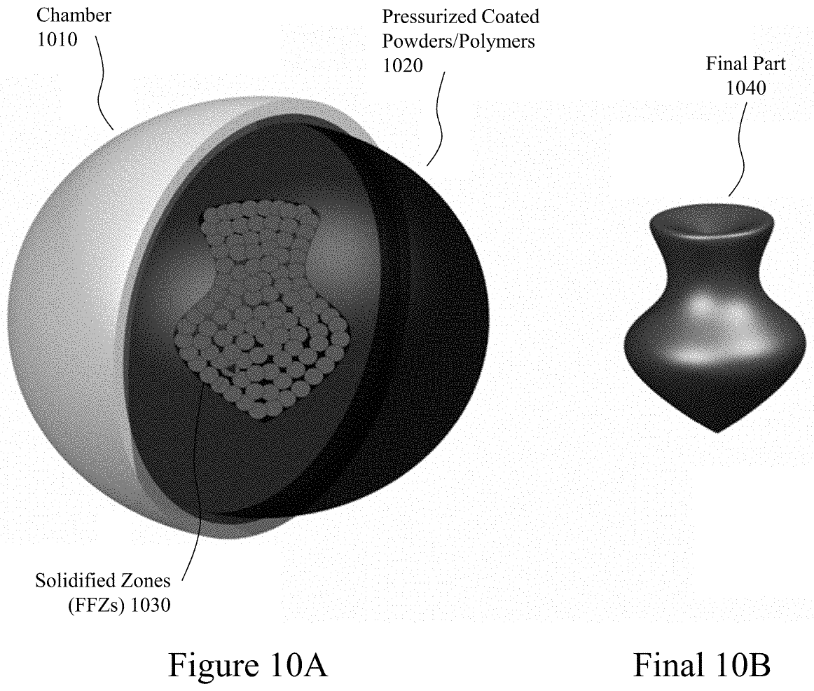

Now referring to FIGS. 10A and 10B respectively there are depicted a three-dimensional perspective cross-section of a spherical chamber with powders and piece-part and CAD rendering of the part being formed by an S3 AM process according to an embodiment of the invention. As depicted in FIG. 10A the chamber 1010 is filled with pressurized coated powders/polymers 1020 within which solidified zones 1030 of the material are formed, each solidified zone 1030 being what the inventors refer to Focused Field Zones (FFZs) where the applied fields from the AM system are focused or combine in phase etc. Accordingly, the FFZs 1030 are formed by scanning the fields within the chamber continuously and/or discretely based upon the CAD model of the piece part 1040 depicted in FIG. 10B.

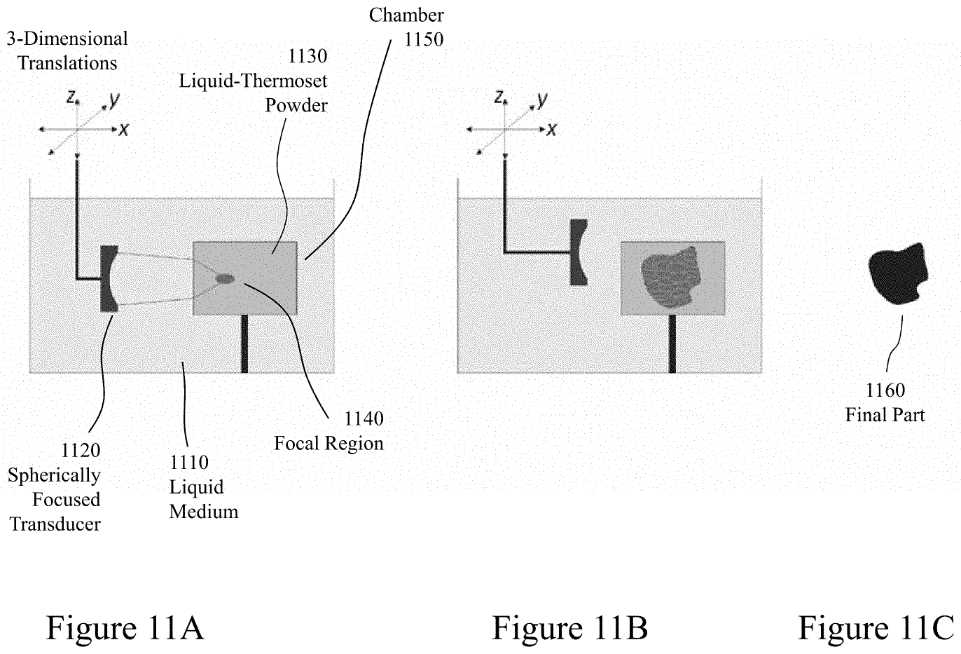

Now referring to FIGS. 11A to 11C respectively there are depicted schematic views of the Selective Spatial Solidification (S3) AM process according to an embodiment of the invention with a liquid material and/or thermoset powder within the chamber 1150 of the AM system. As depicted in FIG. 11A an outer chamber is filled with a liquid medium 1110 for transmission of acoustic energy from the spherically focused transducer 1120 to the focal region 1140 within chamber 1150. Disposed within the chamber 1150 is a liquid or thermosetting powder 1130. Accordingly, agitation induced by the focused acoustic energy at the focal region 1140 within the liquid or thermosetting powder 1130 results in localized pressure and heating and therein thermosetting of the liquid or thermosetting powder 1130. These focal regions of the focused field create affected shaped focal regions can formed as closed small volume, surface or even a free-form volume. These regions, the Field Focal Zones, are overlapped through the process.

Depending upon the design and configuration of the chamber then these FFZs may be spherical within a spherical uniform chamber but within the system configuration of FIG. 11A and many other configurations the FFZs may be elliptical. The configurable focused fields fill the required geometry with these FFZs inside the chamber filled with pressurized powders/polymers or fluid. Each FFZs defines a coating what solidifies and fixes the coordinates of the material. After solidifying the desired regions, which within the system depicted in FIG. 11A is achieved by translating the spherically focused transducer 1120 as indicated in FIG. 11B the finished part 1160 is generated in FIG. 11C. Subsequently this part 1160 may be transferred to another processing station for additional processing, e.g. a furnace for sintering metallic powders.

D1: Material in the Selective Spatial Solidification (S3) Method

Embodiments of the invention may be applied to manufacture metallic, ceramic and polymeric parts. For metallic parts, metal powders may be coated with a thermoset resin which is cured with temperature increase. However, it is possible to use thermoplastic or wax powders mixed with metal powders, in this case, the field increases the temperature of the wax powders and melts them. Then, when the melted wax is solidified in the affected region, the metallic or ceramic powders would be trapped in the solidified region. Ceramic powders can be used to create ceramic parts. The process is similar to metallic parts when the coated ceramic powders are spatially fixed inside the powder chamber.

Polymeric parts can be manufactured out of liquid polymer materials or polymeric powders. In this case, chamber is filled with liquid thermoset. The field selectively increases the temperature inside the chamber and solidifies the liquid thermoset. It is also possible to insert or embed metallic and non-metallic parts inside the chamber to make 3D polymer products with metallic parts in it.

Optionally, parts can be coated with a combination of materials such that an initial thermoset defined accretion may be solidified and then a second material reacted to form a stronger more durable bond for final part use through exposing the interim piece part to one or more chemicals in fluidic form. Accordingly, a wide range of materials may be employed without coatings, with coatings, and exploiting one or more AM excitation means including, but not limited to, ultraviolet radiation, visible radiation, infrared radiation, microwave radiation, X-rays, heat, acoustic radiation, ultrasonic radiation, and hypersonic radiation. In some AM systems a combination of two or more excitation means many be required to “accrete” material to the piece-part.

D2: Field Sources in the Selective Spatial Solidification (S3) Method

Within embodiments of the invention for the S3 AM process then in principle any electromagnetic or non-electromagnetic field can be used in the present patent based on the specifications of the material of the part to be formed through the S3 process. Electromagnetic fields such as ultraviolet radiation, visible radiation, infrared radiation, microwave radiation, X-rays etc. do not need a medium for transmission. However, non-electromagnetic fields such acoustic radiation, ultrasonic radiation, and hypersonic radiation need a medium for transmission. In each case, the focal regions can be created in the 3D space of the chamber using the configuration of the elements as discussed and depicted in respect of FIG. 1 and FIGS. 9A to 9C wherein configurations may support a single electromagnetic or non-electromagnetic field or multiple electromagnetic or non-electromagnetic fields. Any fields that can interfere or focus can be used. Whilst solid state sources should provide the ability to form large arrays through semiconductor processing techniques the embodiments of the invention are not limited to such and accordingly, a single high power laser may be split and coupled using fiber optics or a high power microwave oscillator routed via RF cables or microwave waveguides. Within other embodiments of the invention the discretized elements may be “windows” allowing externally generated electromagnetic or non-electromagnetic fields to be coupled into the chamber.

D3: Setup for Manufacturing Polymer Parts in the Selective Spatial Solidification (S3) Method

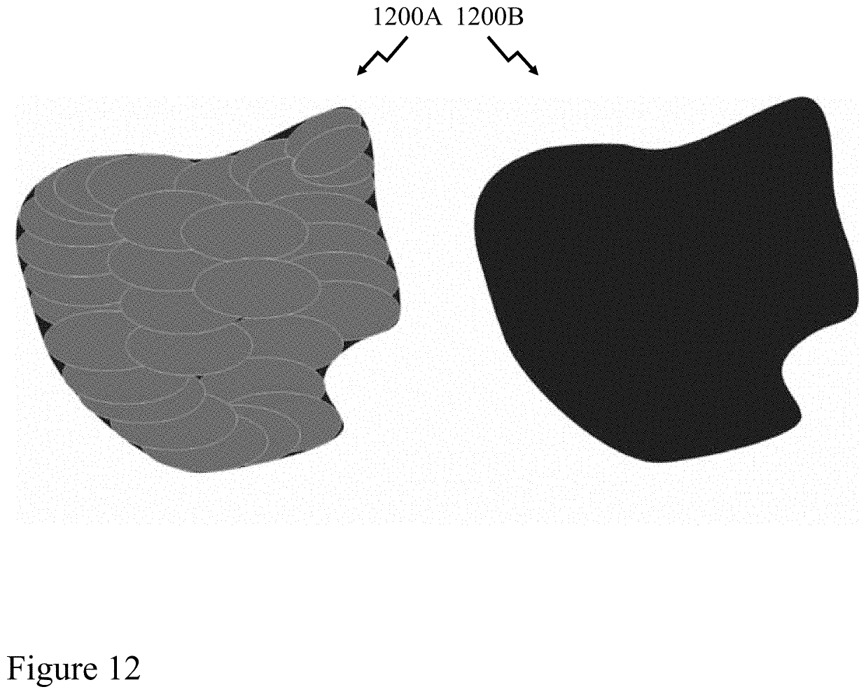

As discussed supra embodiments of the invention may be employed for creating polymeric parts, a setup can be built using single element spherical transducers. As shown in FIG. 11A, the transducer has 3D motion in the liquid medium. This 3D motion is programmed considering the location of FFZs to create the required geometry. The transducer is translated in the liquid medium to fill the geometry of the part inside the liquid thermoset tank with many FFZs as depicted with first image 1200A in FIG. 12. FFZs cure the liquid thermoset (or any heat curing liquid) at the desired spots and solidify the interior and/or boundary regions of the part such that they combine to form the final object 1200B in FIG. 12.

Although the setup shown in FIG. 11 is built based on 3D motion of the single element spherical transducer, any focused field source can be used as discussed above. Accordingly, the FFZ within the chamber, in terms of the focal zone itself and its resulting FFZ shaped region of material can be manipulated for example by moving a single focused source, moving multiple focused sources, moving the chamber relative to a fixed source or sources or through combining fields from discretized elements within the chamber. In this later instance appropriate phase shifting, beam steering, beam direction can continuously sweep the FFZ within the chamber to define the piece part. Accordingly, through appropriate design and control either a series of discrete overlapping FFZs are established and/or a continuous swept FFZ is generated.

D4: FFZs Location Determination in the Selective Spatial Solidification (S3) Method

The center locations of the FFZs is important in achieving an accurate part. As shown in FIG. 12 all the FFZs must be inside or tangent to the outside surfaces of the part. A computer software calculates the center locations of the FFZs based on the physics of the used field (ultrasound, microwave, optical, infrared etc.), materials, etc. It should be mentioned that the FFZ does not always have an elliptical or spherical 3D shape. Based upon on the configuration of the discretized elements on the surface of the chamber, the shape of FFZ can be changed and also transformed into a wider region like a line, curve, surface or a free-form volume in 3D space of the chamber. In more complex AM systems this geometry may be dynamically configured based upon the location of the FFZ relative to the desired external geometry of the piece-part.

E: Selective Spatial Trapping (SST) Method

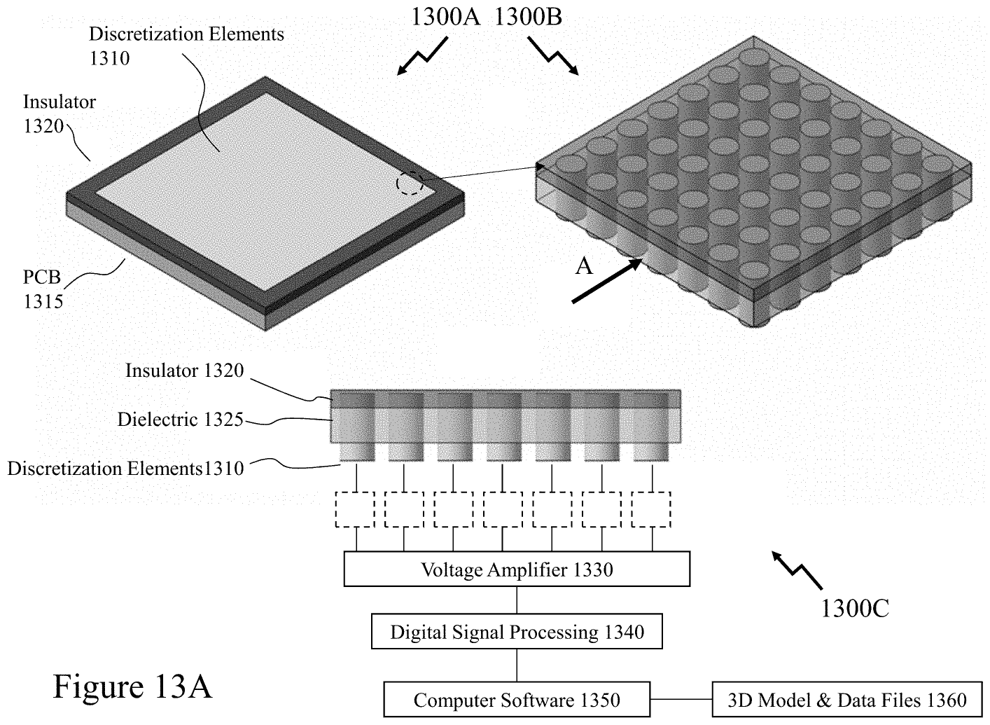

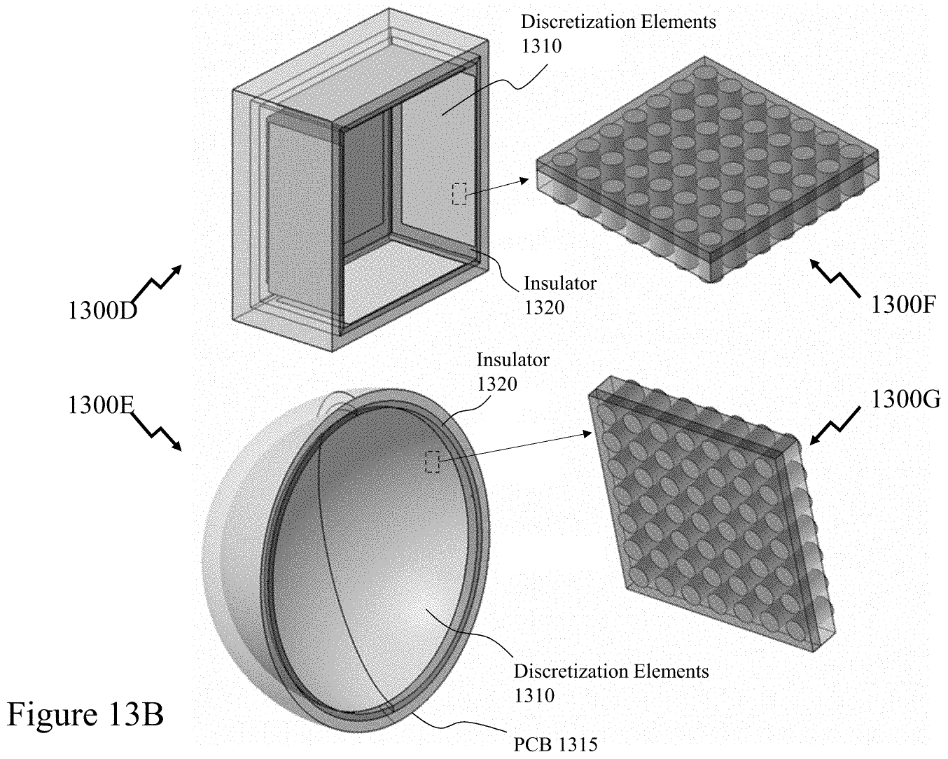

In order to fabricate 2D structures, the electric field could be applied and configured in a 2D workspace such as that shown in FIG. 13A. As described and discussed supra in respect of FIGS. 1A to 2C respectively the inner surfaces of the SST AM processing chamber are covered with discretized element arrays as depicted within FIGS. 13A and 13B to create the desired field, which may be uniform, focused, defocussed, etc., within the chamber in the presence of the pressurized powders or polymers. Referring to FIG. 13A and first image 1300A the discretized elements 1310 are depicted as disposed upon an insulator 1320 and therein upon a PCB 1315 and thereafter body of the chamber, not shown for clarity. The discretized elements 1310 being depicted an in enlarged view 1300B wherein it is evident that the surface of the insulator 1320 is covered with a large number of discretized elements 1310. These as depicted in third view 1300C along direction “A” in enlarged view 1300B may be embedded within a dielectric 1325. The discretized elements 1310 are coupled to the Voltage Amplifier 1330 (or alternate driving means) via optional Attenuator—Phase Shift Elements 1380 according to the type of discretized element 1310 implemented. The Pulse Generator 1330 is coupled to Digital Signal Processing 1340 which takes the data stored within the Computer Software 1350 derived in dependence upon the 3D Model & Data Files 1360 which define the geometry, material, etc.

As depicted in FIG. 13A the discretized elements 1310 are formed upon a planar surface and may provide an implementation of the active field generator structure within an SST AM system according to an embodiment of the invention for some piece-part manufacturing. However, referring to FIG. 13B there are depicted first and second AM systems 1300D and 1300E in rectangular chamber and spherical chamber configurations respectively. Each may represent the full active field generator section of an AM system or it may alternatively represent part with a second mirror assembly providing an enclosed chamber that may be split for maintenance, cleaning, part removal etc. in some embodiments of the invention although it is evident that other configurations may be implemented without departing from the scope of the invention. Each chamber 1330 employs arrays of discretized elements 1310 as depicted in first and second tiles 1300F and 1300G respectively which compose each surface of the inner chamber wall. As depicted the tiles 1300F and 1300G have the same structure as that depicted and discussed in respect of FIG. 13A with enlarged view 1300B and third image 1300C. However, it would be evident that in any of the configurations depicted in FIGS. 13A and 13B respectively that according to the design and requirements of the system that the tiles may be planar, non-planar, portions of a predetermined geometrical shape (e.g. portions of a spherical surface), etc.

D1: Selective Spatial Trapping Case Studies

In the following case studies, the assumptions are for a particle diameter D=150μm and density ρ=2.7 gcm⁻³.

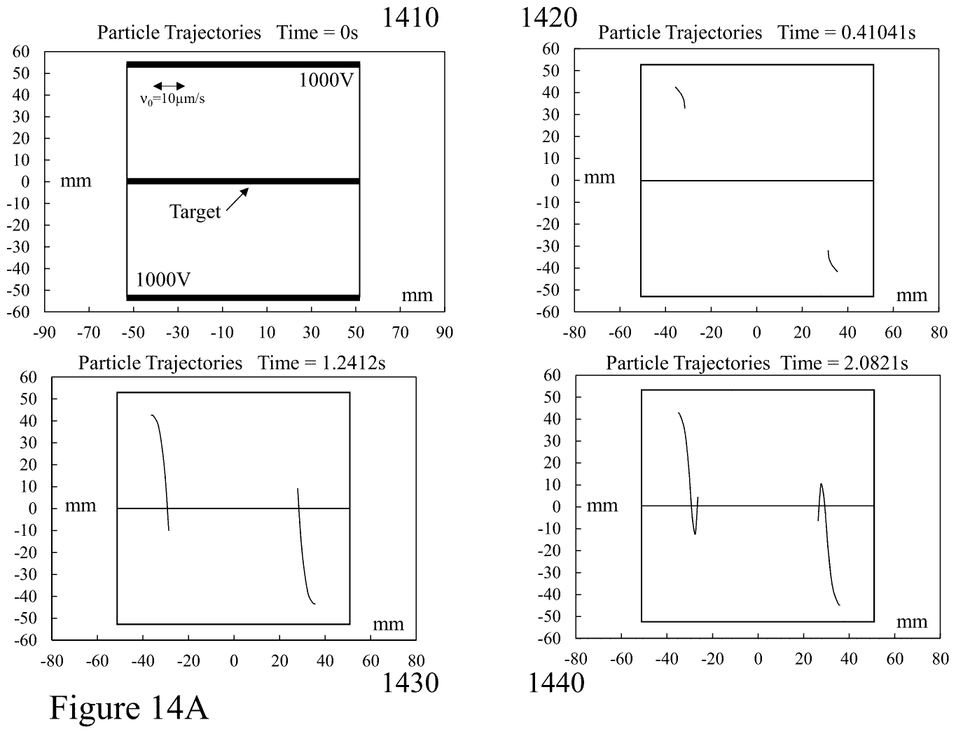

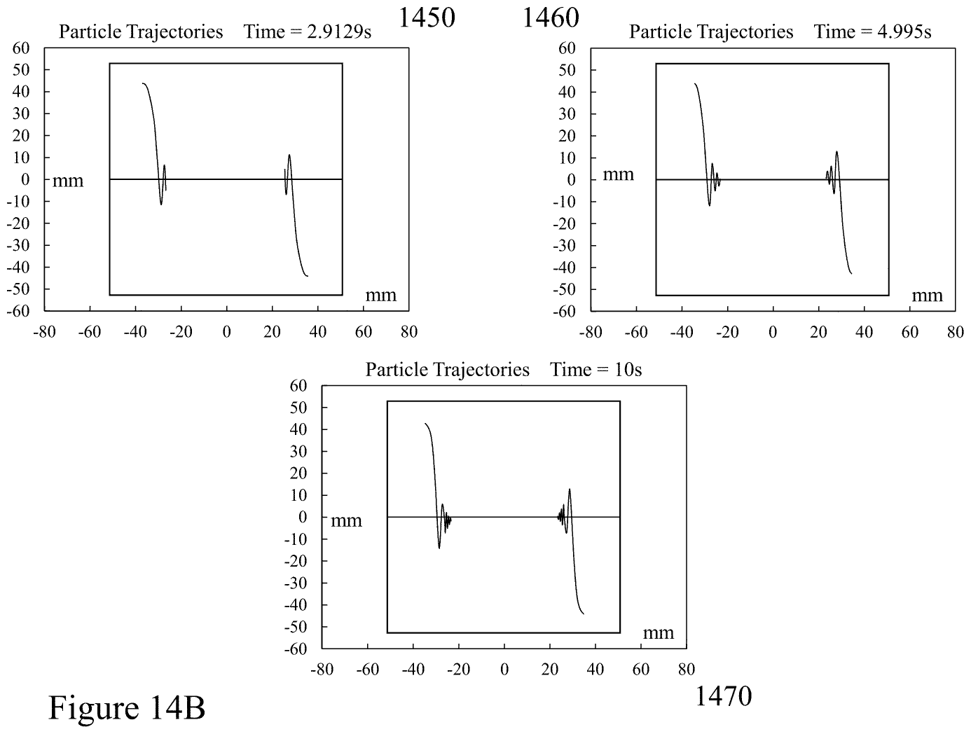

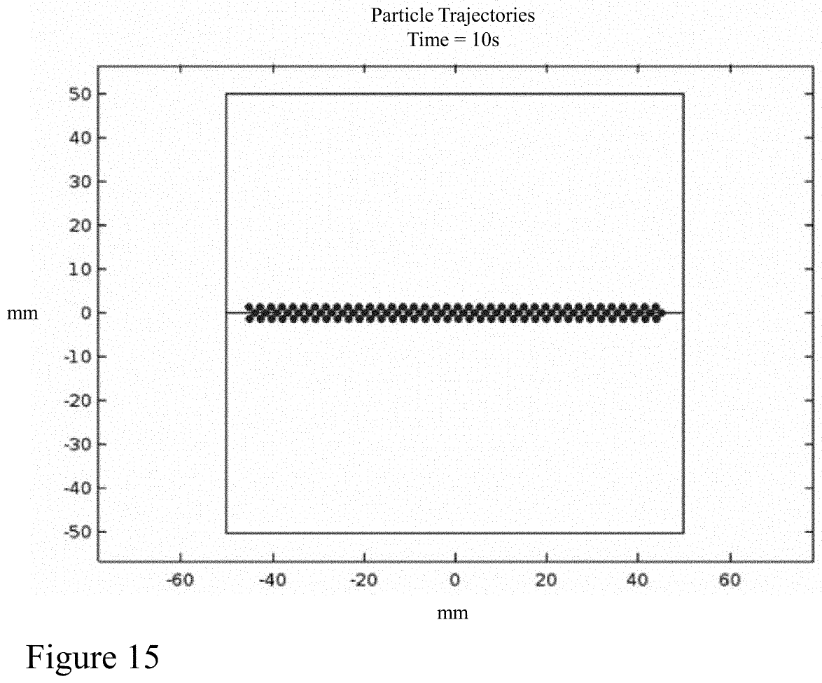

Case I: Two particles are released with initial velocity 10 μm/s. The workspace micro-electrodes apply a voltage of 1000V as depicted by first image 1410 in FIG. 14A. The target is to place the particles on the center line. As it can be seen from FIGS. 14A and 14B with second to seventh images 1420 to 1470 respectively the particles finally are settled at the target. These images being particle trajectories captured at times t=0.41, 1.24, 2.08, 2.91, 5.00, 10.00 seconds after particle release. Releasing many particles in the workspace results in these all settling on the target line as depicted in FIG. 15.

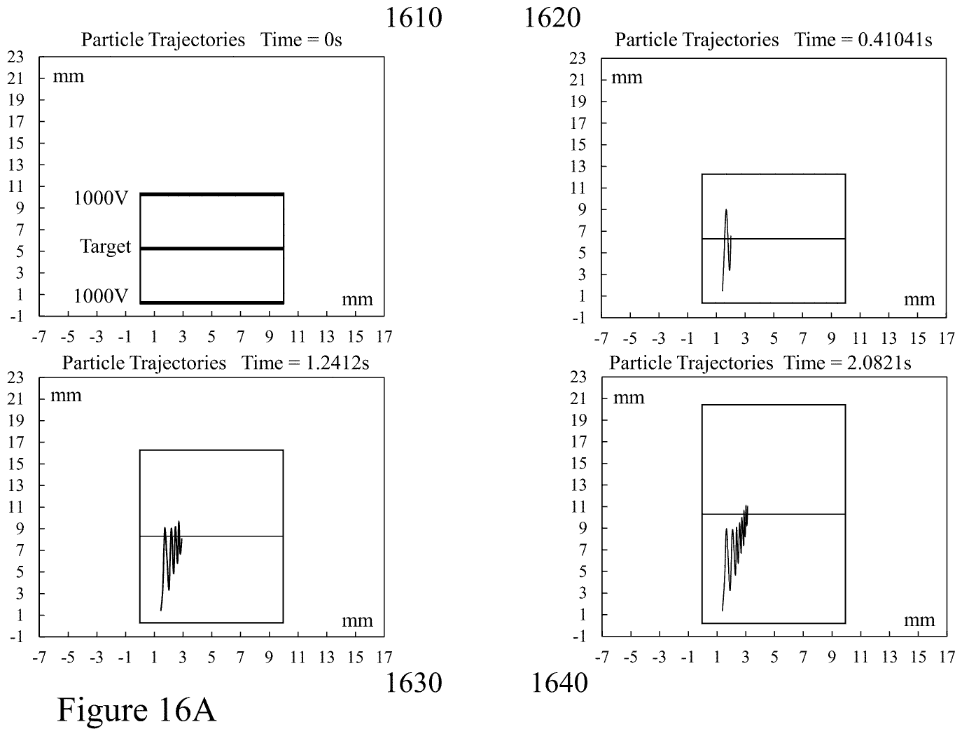

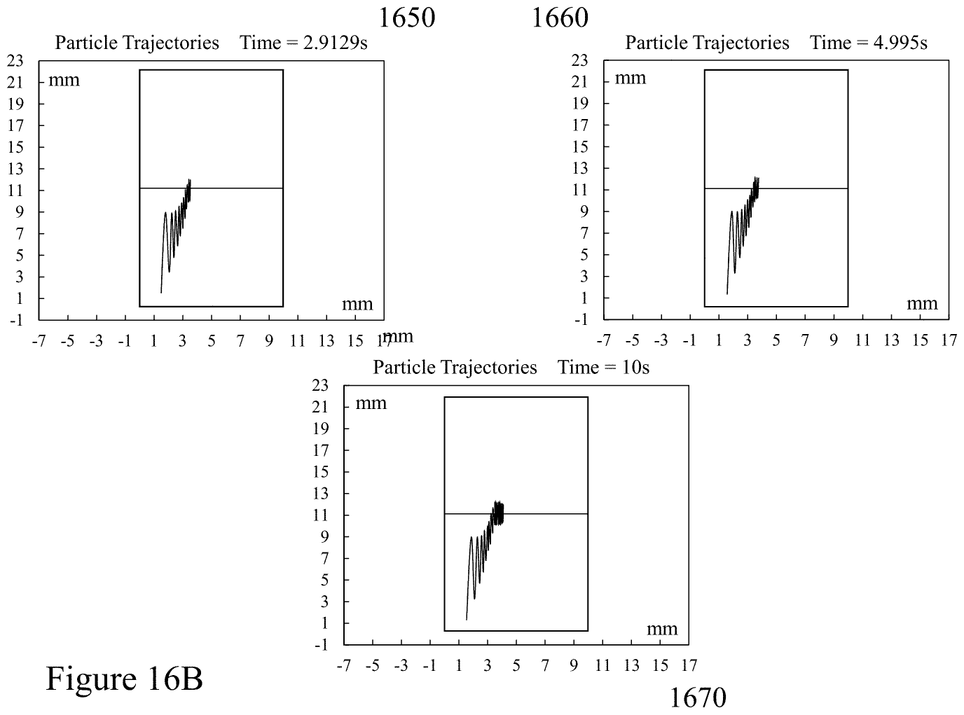

Case II: A particle is released at velocity of 2 mm/s. The plan is to settle the particle on a moving target line with velocity as v₀. Again as depicted in FIG. 16A in first image 1610 the target line is disposed between upper and lower chamber discretized elements set to 1000V. Second to seventh images 1620 to 1670 in FIGS. 16A and 16B depict the resulting particle trajectory at t=0.41, 1.24, 2.08, 2.91, 5.00, 10.00 seconds respectively.

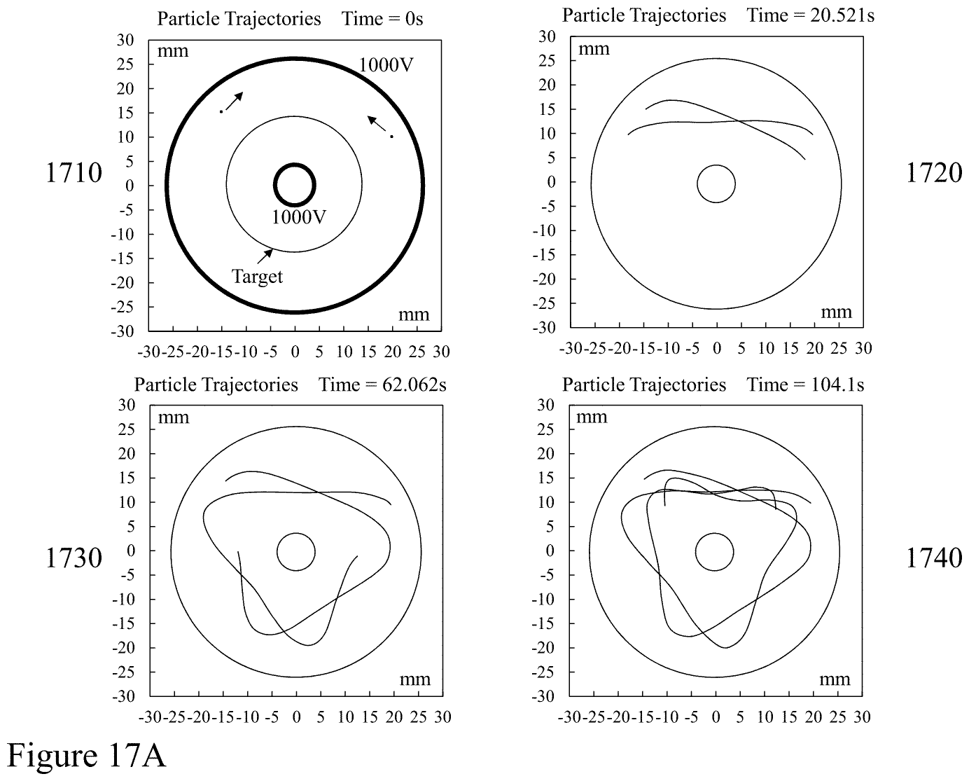

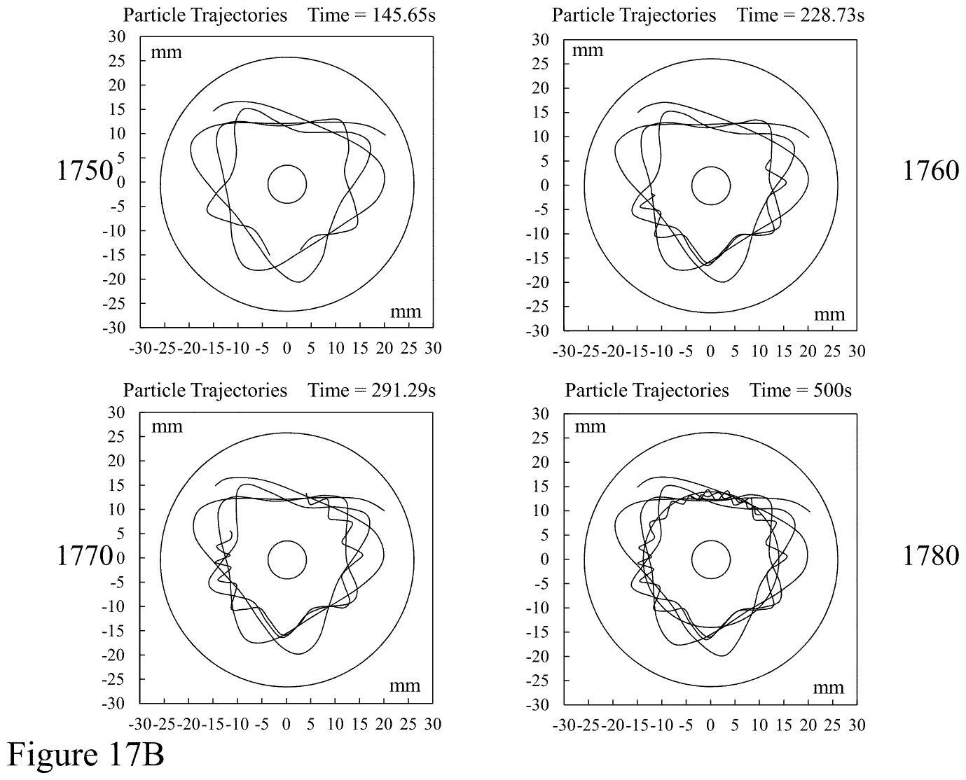

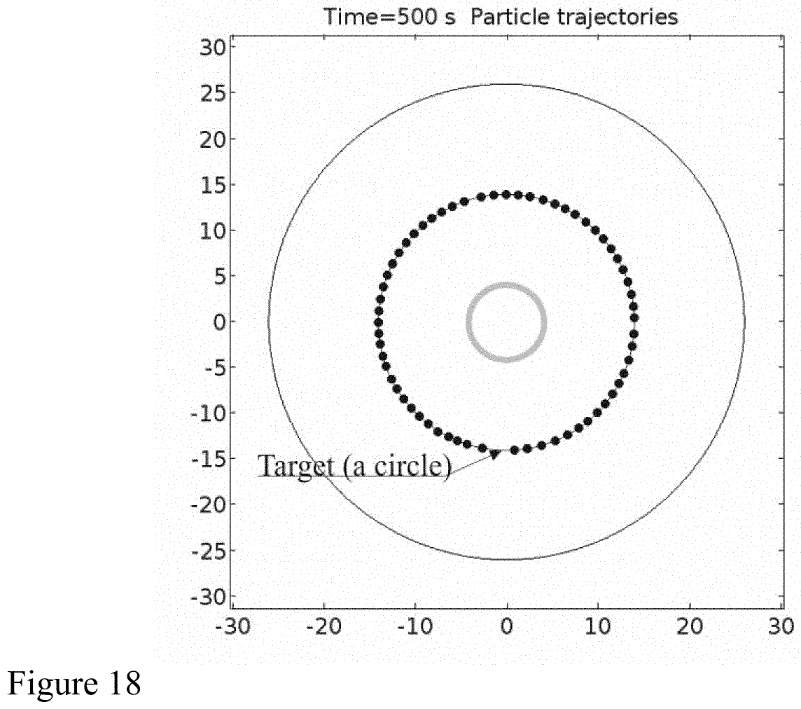

Case III: Two particles are released with initial velocities wherein the intention is to settle the particles onto the target circle identified in first image 1710 in FIG. 17A wherein the target line is disposed between an outer chamber discretized element array at 1000V and an inner micro-electrode array similarly at 1000V. Accordingly, as evident in respect of second to eighth images 1720 to 1780 respectively in FIGS. 17A and 17B. These depict the trajectories at t=20.5, 62.1, 104.1, 145.7, 228.7, 291.3, 500 seconds respectively. As evident from FIG. 18 where multiple particles were launched the particles are gathered and settled on the target circle.

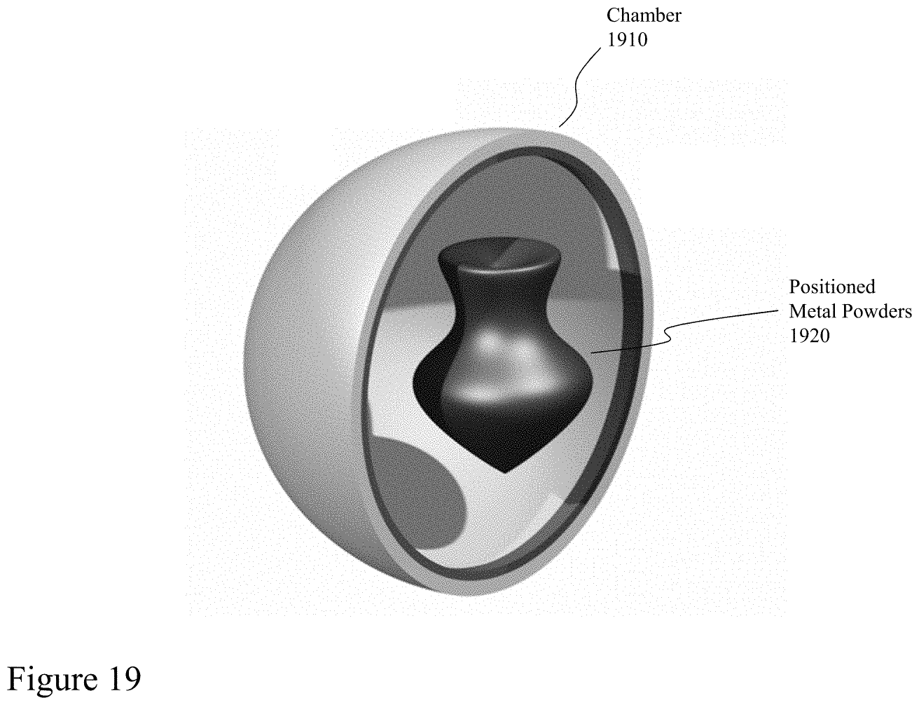

Case IV: FIG. 19 shows the concept of making 3D part in 3D workspace. The powders are inserted inside the chamber. The discretized elements, e.g. electrodes or magnets, on the surface of the chamber apply desired field inside the chamber. The field causes the powers to be placed in the required location to create the desired geometry.

F: S3 and SST Piece-Part Support

Within the preceding description with respect to the S3 and SST AM manufacturing processes the embodiments of the invention have been described with respect to isolated piece-parts. However, it would be evident that within some embodiments of the invention that the piece-part as it is formed may not be supported by the surrounding medium or that its density may be less than that of the surrounding medium and hence it seeks to rise within the chamber. Accordingly, the piece-part may be formed in conjunction with one or more dielectric elements disposed within the chamber wherein the material and geometry of these dielectric elements may vary according to the S3/SST AM process, e.g. high temperature SST of metals might exploit one or more ceramic dielectric elements, whereas a microwave based S3 AM of polymer might exploit polypropylene, for example, which has low dielectric constant and low dielectric loss. In most instances the determination of applied fields would require that in addition to the 3D material and geometry information of the piece-part to be manufactured that the same data for the one or more dielectric elements be included to achieve the correct fields to be generated.

Within some embodiments a low temperature sacrificial dielectric element might be employed such that the dielectric element is removed through increasing the temperature of the piece part. In other embodiments of the invention the dielectric element may provide a fixture for automated and/or manual removal and transfer of the S3/SST manufactured piece part from one layerless AM process to another layerless AM process/layered AM process/conventional process etc.

In other embodiments of the invention according to the design of the piece-part and the chamber the supporting surface may be inner surface of the chamber (3D) or upper surface of the plate (2D).

Accordingly, within some embodiments of the invention the concepts described supra in respect of the provisioning of a dielectric element to support the layerless AM part during processing may be extended such that in addition to the dielectric element a predetermined portion of the piece-part is also provided having been formed from a layerless AM process, a layered AM process, and/or other manufacturing process. For example, a ceramic element formed from S3 based accretion with annealing may upon a mounting element form the carrier for a metallic SST process to deposit electrical connections and elements upon the surface of the ceramic prior to further manufacturing. Alternatively, a ceramic element may have a metallic fixturing element integrated by forming the fixturing element with an SST or S3 process.

G: Layerless-Layered and Layerless-Conventional Manufacturing

As described and discussed supra the S3 and SST layerless AM processes support manufacturing exploiting them as the sole AM process or they may be employed in conjunction with a “layered” AM process as known within the prior art. Accordingly, discrete layerless (single layerless process), multi-layerless (two or more layerless processes), layerless-layered (single layerless), multi-layerless-layered (two or more layerless processes with layered process), layerless-multi-layered (layerless with two or more layered processes) and multi-layerless-multi-layered (two or more layerless processes with two or more layered processes) may be implemented using techniques, processes, and methods according to embodiments of the invention.

H: Numerical Simulation Example

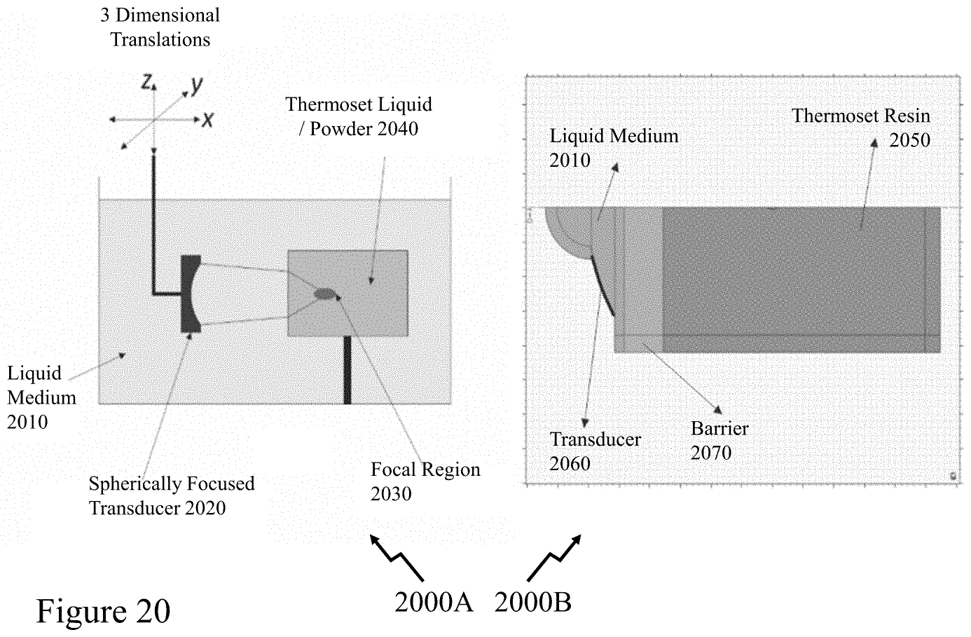

An embodiment of the invention comprising chamber, transducer and the container's wall was modeled using COMSOL software and the activation via sonication simulated by the Finite Element Method (FEM). FIG. 20 depicts in first and second schematics 2000A and 2000B schematic views of the prototype apparatus together with the 2D axisymmetric model simulated. Accordingly, the acoustic pressure and intensity were calculated for the domains depicted in second schematic 2000B in FIG. 20 for an acoustic transducer simulation. The resulting calculated pressure and intensity were then employed as inputs to a heat transfer simulation to calculate the heat transfer in the chamber (the resin's container) and resulting temperature increase at the focal region within the chamber.

The wave equation defined within two-dimensional (2D) axisymmetric cylindrical coordinates can be written as Equation (1) where r, z, p, ω, ρ_{c} and c_{c} are radial and axial coordinates, acoustic pressure, angular frequency, density and speed of sound respectively.

$$\frac{\partial }{\partial r} [ - \frac{r}{{ρ}_{c}} ( \frac{\partial p}{\partial r} ) ] + r \frac{\partial }{\partial z} [ - \frac{1}{{ρ}_{c}} ( \frac{\partial p}{\partial z} ) ] - [ {( \frac{ω}{{c}_{c}} )}^{2} ] \frac{r ρ}{{ρ}_{c}} = 0 \qquad ( 1 )$$

Within the acoustic simulation, the acoustic pressure and intensity were calculated. Table 1 lists some of the input parameters for the acoustic simulation.

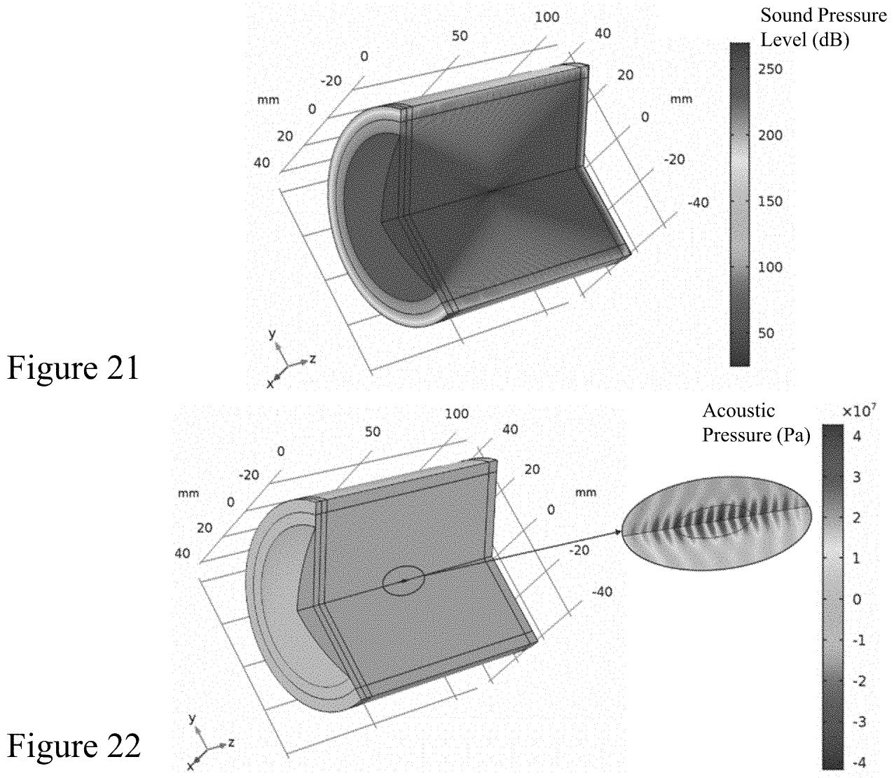

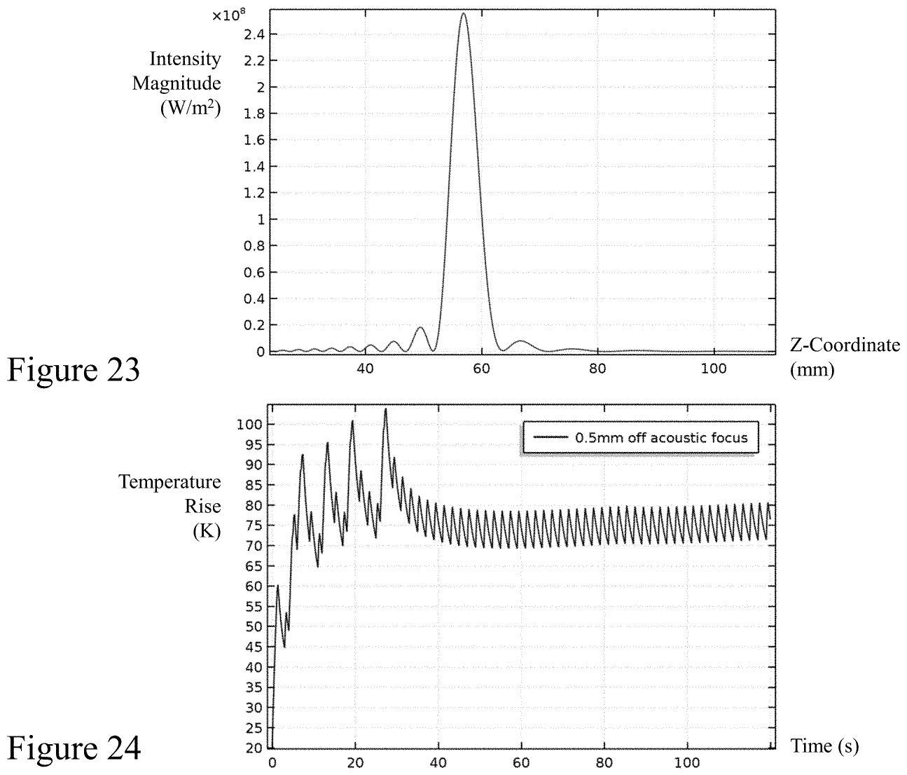

Accordingly, referring to FIGS. 21 and 22 there are depicted the results from simulation of the sound pressure and acoustic pressure within three-dimensional (3D) views of the resin chamber for the input parameters of Table 1. Accordingly, the acoustic intensity, I, on the transducer axis is shown in FIG. 23. The acoustic pressure was then employed within Equation (2) relating to heat transfer in order to calculate the temperature distribution within the simulated apparatus where T is the temperature, p is the density, Cp is the specific heat, k is the thermal conductivity and Q is the heat source (the absorbed ultrasound energy calculated) which can be calculated by Equation (3) where α_{ABs} and I are attenuation coefficient and acoustic intensity, respectively.

TABLE 1
Input Parameters to Simulation

| Parameter | Value | |
|---|---|---|
| Displacement amplitude of transducer | 3.075E−8 | m |
| Starting position of resins | 0.0147 | m |
| Initial temperature value | 293.7 | K |
| Absorption coefficient of water | 0.025 | 1/m |
| Absorption coefficient of resin | 2.4 | 1/m |
| Absorption coefficient of tissue phantom | 5.525 | 1/m |
| Source frequency | 2 | MHz |

$$\begin{matrix}ρ {C}_{p} \frac{\partial T}{\partial t} = ∇ \cdot ( k ∇ T ) + Q & ( 2 ) \\ Q = 2 {α}_{ABS} I = 2 {α}_{ABS} \vert Re ( \frac{1}{2} p v ) \vert & ( 3 )\end{matrix}$$

Accordingly, an input pulse for sonication was estimated to raise the temperature at the focal region to the fast curing temperature of the resin. In the current simulated example, the temperature at the focal region was increased by approximately 75° C. (to 100° C. from 25° C. ambient temperature) in the steady state with a peak temperature increase of approximately 100° C. Accordingly, the temperature can be maintained for the period of time required to cure and solidify the resin in the focal region by continuing the sonication. The temperature increase at the focal region derived from the simulated is depicted in FIG. 24.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1-38. (canceled)

39. A system for forming three-dimensional (3D) structures comprising:
a chamber;
a plurality of surfaces, each surface forming a predetermined portion of the chamber;
a plurality of discretized elements, each discretized element of the plurality of discretized elements for generating an emitted field of a predetermined type and associated with a surface of the plurality of surfaces;
a plurality of field sources, each field source coupled to a predetermined subset of the plurality of discretized elements and each generating predetermined control signals of appropriate characteristics to each discretized element of the predetermined subset of the plurality of discretized elements in dependence upon control data received from a control unit; and
the control unit for generating the control data provided to the plurality of field sources; wherein
the control data is generated in dependence upon of model data relating to a three-dimensional (3D) model of a 3D structure to be formed with the system and material data relating to a build material from which the 3D structure will be formed by the system.

40. The system according to claim 39, wherein
each discretized element of the plurality of discretized elements generates an emitted field that is one of an ultrasonic field, an acoustic field, a hypersonic field, a magnetic field and an electric field.

41. The system according to claim 39, wherein
the control unit calculates for each predetermined portion of a plurality of predetermined portions of the 3D structure a required field configuration; wherein
the required field configuration represents a focus of the emitted fields from a predetermined subset of the plurality of discretized elements;
the predetermined portion of the plurality of predetermined portions represents either a surface portion or an interior portion of the 3D structure; and
the plurality of predetermined portions are formed within a volume of the build material independent of any surface of the build material.

42. The system according to claim 39, wherein
the control data establishes a focused field zone within the chamber through the combination of emitted fields from a predetermined subset of the plurality of discretized elements; wherein
the spatial coordinates of focused field zone may be varied within the chamber allowing the 3D structure to be defined within a volume of the build material within the chamber in a single processing sequence independent of adding new build material to either the chamber or a surface of a partially fabricated portion of the 3D structure.

43. The system according to claim 39, wherein
the plurality of discretized elements comprises at least two subsets of discretized elements; and
each subset of the at least two subsets of discretized elements emit a different field to the other subsets of the at least two subsets of discretized elements.

44. The system according to claim 39, wherein
a subset of the plurality of discretized elements are mounted to one or more translation systems; and
the one or more translation systems allow the relative position of the emitted fields of the subset of the plurality of discretized elements to be varied with respect to the emitted fields of the remainder of the plurality of discretized elements.

45. The system according to claim 39, further comprising
an inner chamber disposed both within the chamber and within the plurality of surfaces; wherein
the build material from which the 3D structure is to be formed is provided only within the inner chamber; and
the region between the inner chamber and the plurality of surfaces is filled with a material selected in dependence upon the emitted fields.

46. The system according to claim 39, wherein
the build material is either a fluid or a resin; and
the predetermined signals emitted from the plurality of discretized elements at least one of interact with and locally raise the temperature of the build material above a predetermined temperature where the predetermined signals combine constructively.

47. The system according to claim 39, wherein
the build material is a powder of particulates wherein each particulate comprises a core and a coating over a predetermined portion of the core;
the core is formed from a first material selected from the group comprising a polymer, a ceramic, a metal, an alloy, and an insulator;
the coating over the predetermined portion of the core is formed from a selected material selected from the group comprising a fluid, a resin, a solid and a powder;
the first material is different to the second material; and
the emitted fields from the plurality of discretized elements at least one of interact with the and locally raise the temperature of the coating of the particulates above a predetermined temperature only within a predetermined spatial region within the build material where the emitted fields combine constructively.

48. The system according to claim 39, wherein
the build material is a powder of particulates wherein each particulate comprises a core and a coating over a predetermined portion of the core sensitive to at least one of an electromagnetic field and mechanical field;
the core is formed from a first material selected from the group comprising a polymer, a ceramic, a metal, an alloy, and an insulator;
the coating over the predetermined portion of the core which is sensitive to at least one of the electromagnetic field and the mechanical field is formed from a selected material selected from the group comprising a fluid, a resin, a solid, and a powder;
the emitted fields from the plurality of discretized elements provide an overall field within the chamber which directs a portion of the build material to a predetermined location within the chamber; and
the emitted fields from the plurality of discretized elements are varied over time to direct subsequent portions of the build material to other predetermined locations within the chamber.

49. The system according to claim 39, wherein
the build material is a powder of particulates that are sensitive to at least one of an electromagnetic field and a mechanical field;
the emitted fields from the plurality of discretized elements provide an overall field within the chamber which directs a portion of the build material to a predetermined location within the chamber; and
the emitted fields from the plurality of discretized elements are varied over time to direct subsequent portions of the build material to other predetermined locations within the chamber.

50. The system according to claim 39, wherein
the build material comprises:
a first predetermined portion comprising a powder of first particulates that are electromagnetic field sensitive; and
a second predetermined portion comprising a powder of second particulates comprising a core and a coating over a predetermined portion of the core sensitive to at least one of an electromagnetic field and a mechanical field; wherein
the core comprises a material selected from the group comprising a polymer, a ceramic, a metal, an alloy, and an insulator; and
the control circuit executes a sequence comprising:
a formation step wherein a first predetermined portion of the plurality of discretized elements emit first predetermined fields to provide an overall field within the chamber direct a portion of the build material to a predetermined location within the chamber; and
a consolidation step wherein a second predetermined portion of the plurality of discretized elements emit second predetermined fields to at least one of:
fuse that portion of the build material together;
fuse that portion of the build material together with a preceding portion of the build material; and
sinter the portion of the build material; and
the control circuit executes the sequence comprising formation steps and consolidation steps over a period of time such that other portions of the build material are directed to other predetermined locations within the chamber to form the 3D structure and are at least one of fused and sintered.

51. The system according to claim 39, wherein
the 3D structure is formed within a volume of the build material independent of any surface of the build material.

52. The system according to claim 39, wherein
the control data relates to:
establishing initial emitted fields from the plurality of discretized elements that form at least one of a static field and a dynamic field which directs build material injected into chamber to an accretion point within the chamber thereby forming a predetermined portion of the 3D structure; and
establishing subsequent emitted fields from the plurality of discretized elements that form at least one of a static field and a dynamic field which directs subsequent build material subsequently injected into the chamber to subsequent accretion points within the chamber thereby forming other portions of the 3D structure;
the 3D structure is formed only from material injected into the chamber; and
the emitted fields are at least one of an electromagnetic field, an electrostatic field and a mechanical field.

53. The system according to claim 39, wherein
at least one of:
the system can form the 3D structure independent of at least one of a magnitude of and a direction of gravity; and
the 3D structure formed by the system using the emitted fields acts as a template for a subsequent additive manufacturing process employing at least one of catalyst triggered nucleation and catalyst triggered deposition.
